(19) United States
(12) Patent Application Publication
(10) Pub. No.: US 2011/0121208 A1
(43) Pub. Date: May 26, 2011

(54) CHARGED PARTICLE BEAM DRAWING APPARATUS AND ELECTRICAL CHARGING EFFECT CORRECTION METHOD THEREOF

(75) Inventors: Noriaki NAKAYAMADA, Kanagawa (JP); Hitoshi HIGURASHI, Kanagawa (JP)

(73) Assignee: NuFlare Technology, Inc., Numazu-shi (JP)

(21) Appl. No.: 12/948,178

(22) Filed: Nov. 17, 2010

(30) Foreign Application Priority Data
Nov. 20, 2009 (JP) 2009-264543

(51) Int. Cl. G21K 5/04

(52) U.S. Cl. 250/492.22

(57) ABSTRACT

A charged particle beam drawing apparatus calculates a pattern area density distribution by using a central processing unit, calculates a dose distribution by using the central processing unit, calculates an irradiation amount distribution by using the central processing unit, performs a convolution calculation of the irradiation amount distribution and a fogging charged particle distribution by using a high speed processing unit, a processing speed of the high speed processing unit being higher than a processing speed of the central processing unit, calculates an irradiation time by using the central processing unit, calculates an elapsed time by using the central processing unit, calculates an electrical charging amount distribution by using the central processing unit, and performs a convolution calculation of the electrical charging amount distribution and a position deviation response function by using the high speed processing unit.

### CROSS-REFERENCE TO RELATED APPLICATION

This application is based upon and claims the benefit of priority from the prior Japanese Patent Application No. 2009-264543 filed on Nov. 20, 2009 in Japan, the entire contents of which are incorporated herein by reference.

### BACKGROUND OF THE INVENTION

1. Field of the Invention

The present invention relates to a charged particle beam drawing apparatus and electrical charging effect correction method thereof, wherein patterns corresponding to figures included in a drawing data are drawn on a resist of a workpiece by applying a charged particle beam to the workpiece, wherein the resist is applied to an upper surface of the workpiece.

2. Description of Related Art

As is known in the prior art, a charged particle beam drawing apparatus performs an electrical charging effect correction process. For example, the charged particle beam drawing apparatus is described in Japanese Unexamined Patent Publication No. 2009-260250.

In the charged particle beam drawing apparatus described in Japanese Unexamined Patent Publication No. 2009-260250, a drawing portion is provided for drawing patterns corresponding to figures included in a drawing data, on a resist of a workpiece by applying a charged particle beam to the workpiece, wherein the resist is applied to an upper surface of the workpiece. In the charged particle beam drawing apparatus described in Japanese Unexamined Patent Publication No. 2009-260250, a pattern area density distribution calculating portion for calculating a pattern area density distribution of patterns drawn by the charged particle beam, and a dose distribution calculating portion for calculating a dose distribution on the basis of the pattern area density distribution and a backscattering ratio of charged particles in the resist, are provided in order to perform the electrical charging effect correction process.

In the charged particle beam drawing apparatus described in Japanese Unexamined Patent Publication No. 2009-260250, an irradiation amount distribution calculating portion for calculating an irradiation amount distribution which is the product of the pattern area density distribution by the dose distribution, and a fogging charged particle amount distribution calculating portion for performing a convolution calculation of the irradiation amount distribution and a fogging charged particle distribution, are provided in order to perform the electrical charging effect correction process. In the charged particle beam drawing apparatus described in Japanese Unexamined Patent Publication No. 2009-260250, an electrical charging amount distribution calculating portion for calculating an electrical charging amount distribution of the resist of the workpiece electrically charged by an irradiation of the charged particle beam, and a position deviation amount map calculating portion for performing a convolution calculation of the electrical charging amount distribution and a position deviation response function, are provided in order to perform the electrical charging effect correction process.

In detail, in the charged particle beam drawing apparatus described in Japanese Unexamined Patent Publication No. 2009-260250, a deviation amount of an irradiation position of the charged particle beam applied to the resist of the workpiece is calculated by the position deviation amount map calculating portion, wherein a deviation of the irradiation position of the charged particle beam applied to the resist of the workpiece is caused by an electrical charging effect. Then, the charged particle beam is deflected by deflectors in order to correct (cancel) the deviation of the irradiation position of the charged particle beam caused by the electrical charging effect.

Japanese Unexamined Patent Publication No. 2009-260250 does not show what is used in order to perform a calculation in the pattern area density distribution calculating portion, a calculation in the dose distribution calculating portion, a calculation in the irradiation amount distribution calculating portion, the calculation in the fogging charged particle amount distribution calculating portion, a calculation in the electrical charging amount distribution calculating portion, and the calculation in the position deviation amount map calculating portion. In general, in the typical charged particle beam drawing apparatus in the prior art, such as the charged particle beam drawing apparatus described in Japanese Unexamined Patent Publication No. 2009-260250, the calculation in the pattern area density distribution calculating portion, the calculation in the dose distribution calculating portion, the calculation in the irradiation amount distribution calculating portion, the calculation in the fogging charged particle amount distribution calculating portion, the calculation in the electrical charging amount distribution calculating portion, and the calculation in the position deviation amount map calculating portion, are performed by using a central processing unit (CPU).

A processing load of the calculation in the fogging charged particle amount distribution calculating portion and the calculation in the position deviation amount map calculating portion, is extremely larger than a processing load of another calculations for performing the electrical charging effect correction process. If the calculation in the fogging charged particle amount distribution calculating portion and the calculation in the position deviation amount map calculating portion are performed in parallel by using a plurality of central processing units, a processing time of the calculation in the fogging charged particle amount distribution calculating portion and the calculation in the position deviation amount map calculating portion can be decreased.

However, a fogging charged particle amount distribution and the electrical charging amount distribution changes, if a shot (an irradiation) of the charged particle beam applied to the resist of the workpiece is performed. Consequently, the calculation in the fogging charged particle amount distribution calculating portion and the calculation in the position deviation amount map calculating portion should be performed in accordance with a sequence of shots (irradiations) of the charged particle beam, in order to precisely calculate a position deviation amount (the position deviation amount map) of the charged particle beam on the basis of the fogging charged particle amount distribution and the electrical charging amount distribution.

In other words, if a plurality of central processing units are used, and if the calculation in the fogging charged particle amount distribution calculating portion and the calculation in the position deviation amount map calculating portion are performed in parallel independently of the sequence of shots (irradiations) of the charged particle beam, the electrical charging effect correction process cannot be precisely performed, although the processing time of the calculation in the fogging charged particle amount distribution calculating portion and the calculation in the position deviation amount map calculating portion can be decreased.

### SUMMARY OF THE INVENTION

An object of the present invention is to provide a charged particle beam drawing apparatus and electrical charging effect correction method thereof, which can precisely perform the electrical charging effect correction process and decrease the processing time for performing the electrical charging effect correction process.

In detail, an object of the present invention is to provide a charged particle beam drawing apparatus and electrical charging effect correction method thereof, wherein the processing time for performing the electrical charging effect correction process can be shorter than a case in which a high speed processing unit is not provided, and a calculation for the electrical charging effect correction process is performed by only a central processing unit, and another case in which the calculation for the electrical charging effect correction process is performed in parallel by the central processing unit and another processing unit which has the same processing speed as the central processing unit.

In accordance with one aspect of the present invention, a charged particle beam drawing apparatus, comprising: a drawing portion for drawing patterns corresponding to figures included in a drawing data, on a resist of a workpiece by applying a charged particle beam to the resist, the resist being applied to an upper surface of the workpiece; a pattern area density distribution calculating portion for calculating a pattern area density distribution of patterns drawn by the charged particle beam; a dose distribution calculating portion for calculating a dose distribution on the basis of the pattern area density distribution and a backscattering ratio of charged particles in the resist; an irradiation amount distribution calculating portion for calculating an irradiation amount distribution, the irradiation amount distribution being a product of the pattern area density distribution by the dose distribution; a fogging charged particle amount distribution calculating portion for performing a convolution calculation of the irradiation amount distribution and a fogging charged particle distribution; an irradiation time calculating portion for calculating an irradiation time of the charged particle beam for drawing the patterns; an elapsed time calculating portion for calculating an elapsed time; an electrical charging amount distribution calculating portion for calculating an electrical charging amount distribution of the resist of the workpiece, the resist of the workpiece being electrically charged by an irradiation of the charged particle beam; a position deviation amount map calculating portion for performing a convolution calculation of the electrical charging amount distribution and a position deviation response function; a central processing unit used for a calculation in the pattern area density distribution calculating portion, a calculation in the dose distribution calculating portion, a calculation in the irradiation amount distribution calculating portion, a calculation in the irradiation time calculating portion, a calculation in the elapsed time calculating portion and a calculation in the electrical charging amount distribution calculating portion; and a high speed processing unit used for the calculation in the fogging charged particle amount distribution calculating portion and the calculation in the position deviation amount map calculating portion, wherein a processing speed of the high speed processing unit is higher than a processing speed of the central processing unit is provided.

In accordance with another aspect of the present invention, an electrical charging effect correction method of a charged particle beam drawing apparatus for drawing patterns corresponding to figures included in a drawing data, on a resist of a workpiece by applying a charged particle beam to the resist, the resist being applied to an upper surface of the workpiece, comprising: performing a calculation of a pattern area density distribution of patterns drawn by the charged particle beam, by using a central processing unit; performing a calculation of a dose distribution on the basis of the pattern area density distribution and a backscattering ratio of charged particles in the resist, by using the central processing unit; performing a calculation of an irradiation amount distribution by using the central processing unit, the irradiation amount distribution being a product of the pattern area density distribution by the dose distribution; performing a convolution calculation of the irradiation amount distribution and a fogging charged particle distribution, by using a high speed processing unit, wherein a processing speed of the high speed processing unit is higher than a processing speed of the central processing unit; performing a calculation of an irradiation time of the charged particle beam for drawing the patterns, by using the central processing unit; performing a calculation of an elapsed time by using the central processing unit; performing a calculation of an electrical charging amount distribution of the resist of the workpiece by using the central processing unit, the resist of the workpiece being electrically charged by an irradiation of the charged particle beam; and performing a convolution calculation of the electrical charging amount distribution and a position deviation response function, by using the high speed processing unit is provided.

Other and further objects, features and advantages of the invention will appear more fully from the following description.

### BRIEF DESCRIPTION OF THE DRAWINGS

FIG. 1 is a schematic illustration of a first embodiment of a charged particle beam drawing apparatus 10 according to the present invention;

FIG. 2 shows a control computer 10b1 of a control portion 10b of the charged particle beam drawing apparatus 10 of the first embodiment shown in FIG. 1, in detail;

FIG. 3 shows an electrical charging effect correction processing portion 10b1b of the control computer 10b1 shown in FIG. 2, in detail;

FIG. 4 shows an example of a pattern PA which can be drawn on a resist of a workpiece M by a shot of a charged particle beam 10a1b in the charged particle beam drawing apparatus 10 of the first embodiment;

FIG. 5 shows an example of a part of a drawing data shown in FIGS. 1 and 2;

FIG. 6 explains a sequence of drawing of patterns PA1, PA2, PA3 corresponding to figures FG1, FG2, FG3 included in the drawing data by means of the charged particle beam 10a1b;

FIGS. 7A, 7B, 7C, 7D, 7E, 7F and 7G schematically explain an electrical charging of the resist caused by drawing the patterns PA1, PA2, PA3 shown in FIG. 6, a position deviation of the charged particle beam 10a1b, and an electrical charging effect correction for cancelling the position deviation of the charged particle beam 10a1b;

FIG. 8A is a pattern area density distribution map which shows a value of a pattern area density distribution ρ(x,y) in a stripe frame STR1 in a drawing area DA of the workpiece M, FIG. 8B is a dose distribution map which shows a value of a dose distribution D(x,y) in the stripe frame STR1 in the drawing area DA of the workpiece M, and FIG. 8C is an irradiation amount distribution map which shows a value of an irradiation amount distribution E(x,y) in the stripe frame STR1 in the drawing area DA of the workpiece M;

FIG. 9A is a fogging charged particle amount distribution map which shows a value of a fogging charged particle amount distribution (fogging electron amount distribution) F(x,y), FIG. 9B is an electrical charging amount distribution map which shows a value of an electrical charging amount distribution C(x,y), and FIG. 9C is a position deviation amount map ρ(x,y) in all of the stripe frame STR1 in the drawing area DA of the workpiece M;

FIG. 10A shows a processing time (elapsed time) of an electrical charging effect correction process in the charged particle beam drawing apparatus 10 of the first embodiment, and FIG. 10B shows a processing time (elapsed time) of the electrical charging effect correction process in a typical charged particle beam drawing apparatus;

FIG. 11 shows the electrical charging effect correction processing portion 10b1b of the charged particle beam drawing apparatus 10 of a third embodiment, in detail;

FIG. 12 is a graph showing a result of a calculation of a position deviation amount of the charged particle beam with respect to a surface point electric charge of +1 nC;

FIG. 13A is the electrical charging amount distribution map of the charged particle beam drawing apparatus 10 of the third embodiment at the time when all of irradiations of the charged particle beam 10a1b in the stripe frame STR1 in the drawing area DA (see FIG. 6) of the workpiece M are completed, and FIG. 13B shows a position deviation response function r(x,y) of the charged particle beam drawing apparatus 10 of the third embodiment at the time when all of the irradiations of the charged particle beam 10a1b in the stripe frame STR1 in the drawing area DA of the workpiece M are completed, where r(x,y)=r1(x,y)+r2(x,y);

FIG. 14 shows the processing time of the electrical charging effect correction process in the charged particle beam drawing apparatus 10 of the third embodiment;

FIG. 15 shows an example of a first position deviation response function rₓ(x,y) for calculating a first component px in an x direction of a position deviation amount p;

FIG. 16 shows an example of a second position deviation response function r_{y}(x,y) for calculating a second component py in a y direction of the position deviation amount p;

FIG. 17 is a graph showing a relation between a distance (radius) from an irradiation position of the charged particle beam 10a1b and a fogging charged particle amount (fogging electron amount);

FIG. 18 shows a first irradiation amount distribution map and a second irradiation amount distribution map of the charged particle beam drawing apparatus 10 of a fifth embodiment at the time when all of irradiations of the charged particle beam 10a1b in the stripe frame STR1 in the drawing area DA of the workpiece M is completed; and

FIG. 19 shows the processing time of the electrical charging effect correction process in the charged particle beam drawing apparatus 10 of the fifth embodiment.

### DETAILED DESCRIPTION OF THE INVENTION

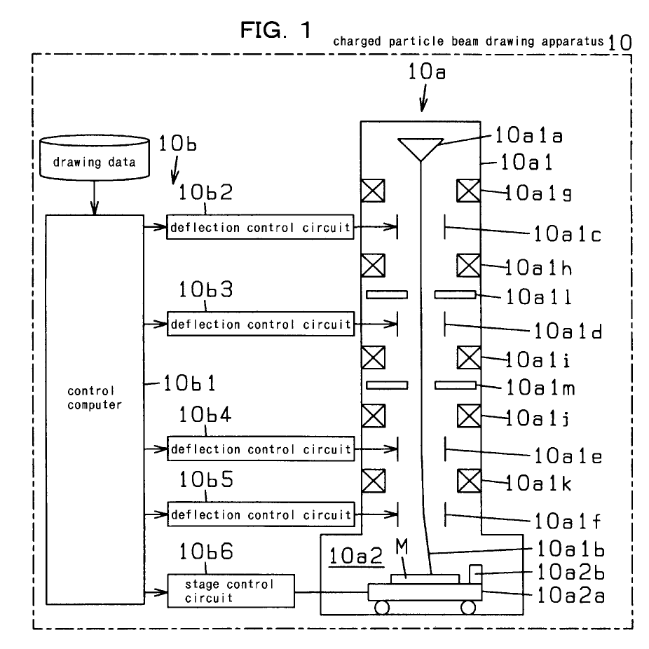

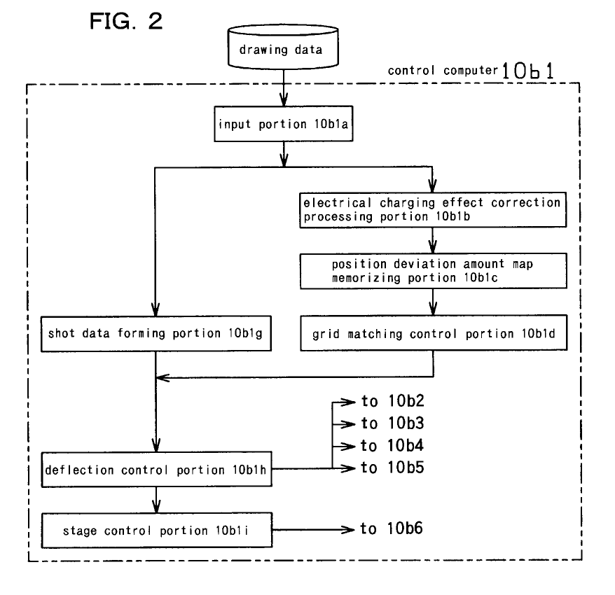

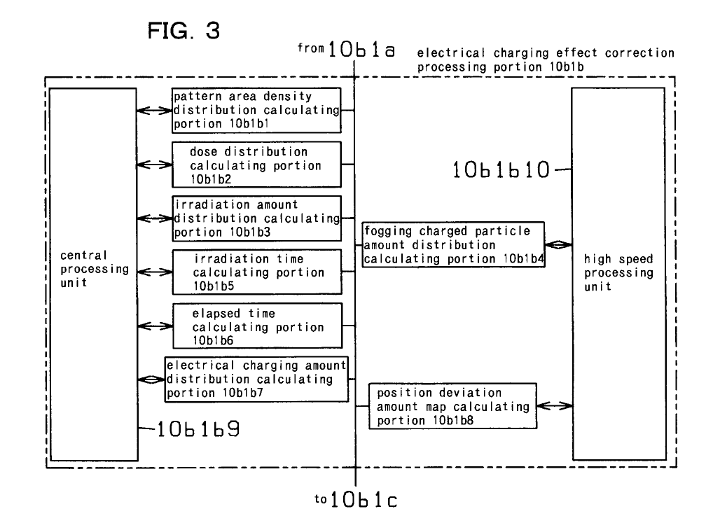

FIG. 1 is a schematic illustration of a first embodiment of a charged particle beam drawing apparatus 10 according to the present invention. FIG. 2 shows a control computer 10b1 of a control portion 10b of the charged particle beam drawing apparatus 10 of the first embodiment shown in FIG. 1, in detail. FIG. 3 shows an electrical charging effect correction processing portion 10b1b of the control computer 10b1 shown in FIG. 2, in detail.

As shown in FIG. 1, the charged particle beam drawing apparatus 10 of the first embodiment has a drawing portion 10a for drawing patterns on a resist of a workpiece M such as a musk (blank) and a wafer, by irradiating the workpiece M with a charged particle beam 10a1b, wherein the resist is applied to an upper surface of the workpiece.

In the charged particle beam drawing apparatus 10 of the first embodiment, an electron beam is used as the charged particle beam 10a1b. In the charged particle beam drawing apparatus 10 of a second embodiment, a charged particle beam such as an ion beam, except the electron beam can be used as the charged particle beam 10a1b.

In the charged particle beam drawing apparatus 10 of the first embodiment, as shown in FIG. 1, the drawing portion 10a has a charged particle beam gun 10a1a, deflectors 10a1c, 10a1d, 10a1e, 10a1f for deflecting the charged particle beam 10a1b emitted from the charged particle beam gun 10a1a, and a movable stage 10a2a for supporting the workpiece M. Patterns are drawn on the workpiece M by the charged particle beam 10a1b deflected by the deflectors 10a1c, 10a1d, 10a1e, 10a1f.

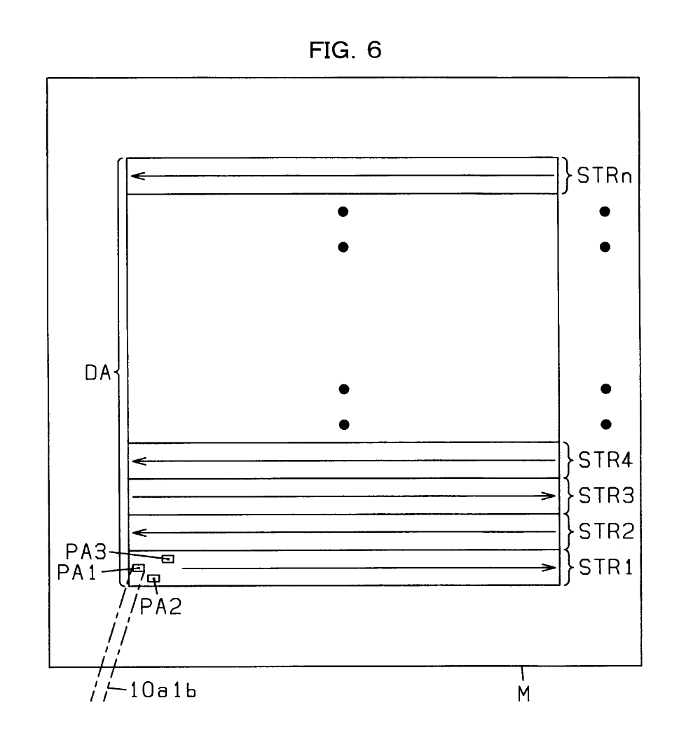

In the charged particle beam drawing apparatus 10 of the first embodiment, as shown in FIG. 1, a drawing chamber 10a2 composes a part of the drawing portion 10a. The movable stage 10a2a for supporting the workpiece M and a laser interferometer 10a2b are placed in the drawing chamber 10a2. The stage 10a2a is movable in an X direction (right and left direction in FIG. 6) and movable in a Y direction (up and down direction in FIG. 6).

In the charged particle beam drawing apparatus 10 of the first embodiment, as shown in FIG. 1, an optical column 10a1 composes a part of the drawing portion 10a. The charged particle beam gun 10a1a, the deflectors 10a1c, 10a1d, 10a1e, 10a1f, lenses 10a1g, 10a1h, 10a1i, 10a1j, 10a1k, a first forming aperture member 10a1l and a second forming aperture member 10a1m are placed in the optical column 10a1.

In the charged particle beam drawing apparatus 10 of the first embodiment, as shown in FIGS. 1 and 2, a drawing data corresponding to a drawing area DA (see FIG. 6) of the workpiece M is inputted to the control computer 10b1, and then, the drawing data is read by an input portion 10b1a and transferred to a shot data forming portion 10b1g. Then, the drawing data transferred to the shot data forming portion 10b1g is processed, so that a shot data for irradiating the resist of the workpiece M with the charged particle beam 10a1b is formed in order to draw patterns on the resist of the workpiece M. Then, the shot data is transferred from the shot data forming portion 10b1g to a deflection control portion 10b1h.

In the charged particle beam drawing apparatus 10 of the first embodiment, as shown in FIGS. 1 and 2, the drawing data read by the input portion 10b1a is also transferred to the electrical charging effect correction processing portion 10b1b. Then, a process which is mentioned below in detail, is performed by the electrical charging effect correction processing portion 10b1b on the basis of the drawing data transferred to the electrical charging effect correction processing portion 10b1b, so that a position deviation amount map p(x,y) is formed. Then, the position deviation amount map p(x,y) is memorized by a position deviation amount map memorizing portion 10b1c.

Then, in the charged particle beam drawing apparatus 10 of the first embodiment, as shown in FIGS. 1 and 2, the deflectors 10a1c, 10a1d, 10a1e, 10a1f are controlled by the deflection control portion 10b1h on the basis of the shot data transferred from the shot data forming portion 10b1g to the deflection control portion 10b1h. Accordingly, the charged particle beam 10a1b emitted from the charged particle beam gun 10a1a is applied to a predetermined position on the resist of the workpiece M.

In detail, in the charged particle beam drawing apparatus 10 of the first embodiment, as shown in FIGS. 1 and 2, if the charged particle beam 10a1b emitted from the charged particle beam gun 10a1a toward the predetermined position on the resist of the workpiece M deviates from the predetermined position on the resist of the workpiece M under an influence of an electrical charging effect of the resist, a control for correcting a position deviation of the charged particle beam 10a1b caused by the electrical charging effect of the resist is performed by a grid matching control portion 10b1d on the basis of the position deviation amount map p(x,y) memorized by the position deviation amount map memorizing portion 10b1c. Concretely, the charged particle beam 10a1b is deflected by a main deflector 10a1f, so that the position deviation of the charged particle beam 10a1b caused by the electrical charging effect of the resist is cancelled. Consequently, in the charged particle beam drawing apparatus 10 of the first embodiment, the charged particle beam 10a1b is precisely applied to the predetermined position on the resist of the workpiece M.

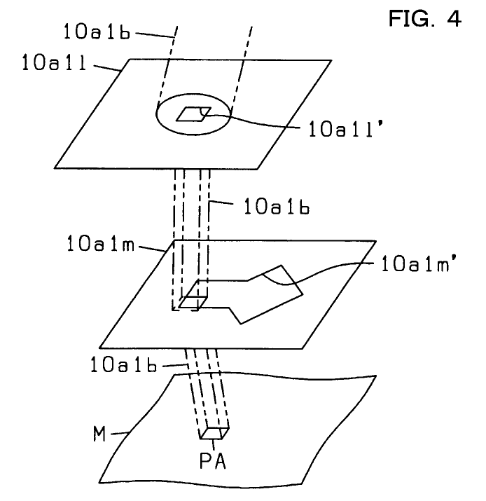

In detail, in the charged particle beam drawing apparatus 10 of the first embodiment, as shown in FIGS. 1 and 2, the charged particle beam 10a1b emitted from the charged particle beam gun 10a1a is passed through an opening 10a1l′ (see FIG. 4) of the first forming aperture member 10a1l and the workpiece M is irradiated with the charged particle beam 10a1b, or the charged particle beam 10a1b emitted from the charged particle beam gun 10a1a is interrupted by a part of the first forming aperture member 10a1l except the opening 10a1l′ and the workpiece M is not irradiated with the charged particle beam 10a1b, by controlling a blanking deflector 10a1c via a deflection control circuit 10b2 by means of the deflection control portion 10b1h on the basis of the shot data formed by the shot data forming portion 10b1g. In other words, in the charged particle beam drawing apparatus 10 of the first embodiment, an irradiate time of the charged particle beam 10a1b can be controlled by controlling the blanking deflector 10a1c.

In the charged particle beam drawing apparatus 10 of the first embodiment, as shown in FIGS. 1 and 2, a beam size changing deflector 10a1d is controlled via a deflection control circuit 10b3 by the deflection control portion 10b1h on the basis of the shot data formed by the shot data forming portion 10b1g, so that the charged particle beam 10a1b passed through the opening 10a1l′ (see FIG. 4) of the first forming aperture member 10a1l is deflected by the beam size changing deflector 10a1d. And then, a part of the charged particle beam 10a1b deflected by the beam size changing deflector 10a1d is passed through an opening 10a1m′ (see FIG. 4) of the second forming aperture member 10a1m. In other words, in the charged particle beam drawing apparatus 10 of the first embodiment, size or shape of the charged particle beam 10a1b applied to the workpiece M can be adjusted by adjusting deflecting amount or deflecting direction of the charged particle beam 10a1b deflected by the beam size changing deflector 10a1d.

FIG. 4 shows an example of a pattern PA which can be drawn on the resist of the workpiece M by a shot of the charged particle beam 10a1b in the charged particle beam drawing apparatus 10 of the first embodiment. In the charged particle beam drawing apparatus 10 of the first embodiment, as shown in FIGS. 1 and 4, when the pattern PA (see FIG. 4) is drawn on the resist of the workpiece M by the charged particle beam 10a1b, a part of the charged particle beam 10a1b emitted from the charged particle beam gun 10a1a (see FIG. 1) is passed through the square opening 10a1l′ (see FIG. 4) of the first forming aperture member 10a1l. So that, a horizontal sectional shape of the charged particle beam 10a1b passed through the opening 10a1l′ of the first forming aperture member 10a1l is almost square. And then, a part of the charged particle beam 10a1b passed through the opening 10a1l′ of the first forming aperture member 10a1l is passed through the opening 10a1m′ (see FIG. 4) of the second forming aperture member 10a1m.

In the charged particle beam drawing apparatus 10 of the first embodiment, as shown in FIGS. 1 and 4, a horizontal sectional shape of the charged particle beam 10a1b passed through the opening 10a1m′ (see FIG. 4) of the second forming aperture member 10a1m can be rectangular (square or oblong) or triangular, by deflecting the charged particle beam 10a1b passed through the opening 10a1l′ of the first forming aperture member 10a1l by means of the deflector 10a1d (see FIG. 1).

In the charged particle beam drawing apparatus 10 of the first embodiment, as shown in FIGS. 1 and 4, the pattern PA (see FIG. 4) having the same shape as the horizontal sectional shape of the charged particle beam 10a1b passed through the opening 10a1m′ (see FIG. 4) of the second forming aperture member 10a1m can be drawn on the resist of the workpiece M, by applying the charged particle beam 10a1b passed through the opening 10a1m′ (see FIG. 4) of the second forming aperture member 10a1m, to a predetermined position on the resist of the workpiece M, for a predetermined time.

In the charged particle beam drawing apparatus 10 of the first embodiment, as shown in FIGS. 1 and 2, a sub-deflector 10a1e is controlled via a deflection control circuit 10b4 by the deflection control portion 10b1h on the basis of the shot data formed by the shot data forming portion 10b1h, so that the charged particle beam 10a1b passed through the opening 10a1m′ (see FIG. 4) of the second forming aperture member 10a1m is deflected by the sub-deflector 10a1e.

In the charged particle beam drawing apparatus 10 of the first embodiment, as shown in FIGS. 1 and 2, the main deflector 10a1f is controlled via a deflection control circuit 10b5 by the grid matching control portion 10b1d and the deflection control portion 10b1h, on the basis of the shot data formed by the shot data forming portion 10b1h and the position deviation amount map p(x,y) memorized by the position deviation amount map memorizing portion 10b1c, so that the charged particle beam 10a1b deflected by the sub-deflector 10a1e is deflected by the main deflector Half.

In the charged particle beam drawing apparatus 10 of the first embodiment, an irradiate position of the charged particle beam 10a1b on the resist of the workpiece M can be adjusted by adjusting deflecting amount and deflecting direction of the charged particle beam 10a1b by means of the sub-deflector 10a1e and the main deflector 10a1f.

In the charged particle beam drawing apparatus 10 of the first embodiment, as shown in FIGS. 1 and 2, movement of the movable stage 10a2a is controlled via a stage control circuit 10b6 by a stage control portion 10b1i on the basis of the shot data formed by the shot data forming portion 10b1h and an output of the laser interferometer 10a2b.

In the example shown in FIGS. 1 and 2, a CAD data (layout data, design data) prepared by a designer such as a semiconductor integrated circuit designer, is converted into the drawing data of a format of the charged particle beam drawing apparatus 10. And then, the drawing data is inputted to the control computer 10b1 of the control portion 10b of the charged particle beam drawing apparatus 10. In general, a plurality of small patterns are included in the CAD data (layout data, design data), so that an amount of the CAD data (layout data, design data) is very large. In general, after the CAD data (layout data, design data) is converted into a different format data, an amount of the data increases. Therefore, in order to compress an amount of the drawing data, the drawing data inputted to the control computer 10b1 of the control portion 10b of the charged particle beam drawing apparatus 10 has a hierarchical structure.

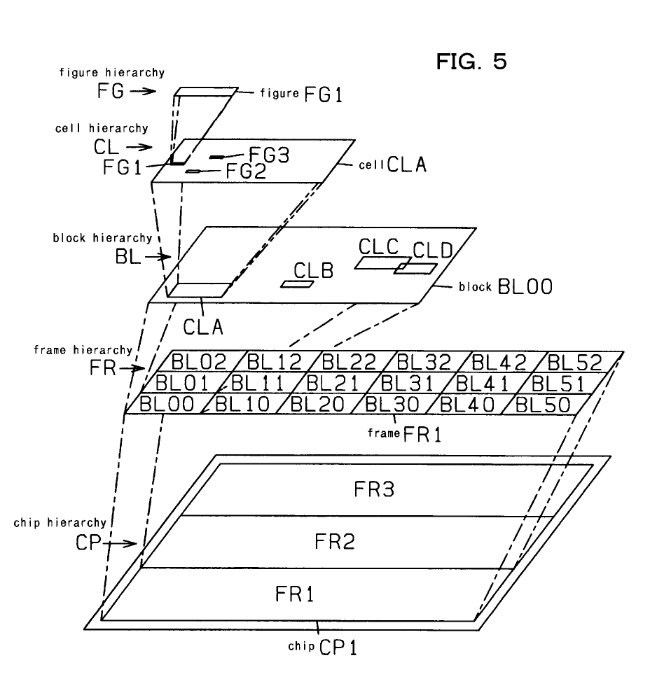

FIG. 5 shows an example of a part of the drawing data shown in FIGS. 1 and 2. In the example shown in FIG. 5, the drawing data applied to the charged particle beam drawing apparatus 10 of the first embodiment, has a chip hierarchy CP, a frame hierarchy FR which is lower than the chip hierarchy CP, a block hierarchy BL which is lower than the frame hierarchy FR, a cell hierarchy CL which is lower than the block hierarchy BL, and a figure hierarchy FG which is lower than the cell hierarchy CL.

In the example shown in FIG. 5, a chip CP1 is one of elements of the chip hierarchy CP, and corresponds to three frames FR1, FR2, FR3. The frame FR1 is one of elements of the frame hierarchy FR, and corresponds to eighteen blocks BL00, BL10, BL20, BL30, BL40, BL50, BL01, BL11, BL21, BL31, BL41, BL51, BL02, BL12, BL22, BL32, BL42, BL52. The block BL00 is one of elements of the block hierarchy BL, and corresponds to cells CLA, CLB, CLC, CLD etc. The cell CLA is one of elements of the cell hierarchy CL, and corresponds to a plurality of figures FG1, FG2, FG3 etc. Each of the figures FG1, FG2, FG3 etc. is one of elements of the figure hierarchy FG.

In the charged particle beam drawing apparatus 10 of the first embodiment, as shown in FIGS. 1, 2 and 5, the charged particle beam 10a1b (see FIG. 1) draws patterns PA1, PA2, PA3 (see FIG. 6) etc. in the drawing area DA (see FIG. 6) of the workpiece M (see FIGS. 1 and 6), and the patterns PA1, PA2, PA3 (see FIG. 6) etc. correspond to the plurality of figures FG1, FG2, FG3 (see FIG. 5) etc. in the figure hierarchy FG (see FIG. 5) in the drawing data.

FIG. 6 explains a sequence of drawing of the patterns PA1, PA2, PA3 corresponding to the figures FG1, FG2, FG3 included in the drawing data by means of the charged particle beam 10a1b. In an example shown in FIG. 6, the drawing area DA of the workpiece M is virtually divided into belt-shaped (rectangular) stripe frames STR1, STR2, STR3, STR4 to STRn, wherein the number of the stripe frames STR1, STR2, STR3, STR4 to STRn is n.

In the example shown in FIG. 6, the charged particle beam 10a1b is scanned in the stripe frame STR1 from a left side of FIG. 6 to a right side of FIG. 6, so that the patterns PA1, PA2, PA3 etc. corresponding to the plurality of the figures FG1, FG2, FG3 (see FIG. 5) etc. included in the drawing data are drawn in the stripe frame STR1 of the workpiece M by the charged particle beam 10a1b. Then, the charged particle beam 10a1b is scanned in the stripe frame STR2 from the right side of FIG. 6 to the left side of FIG. 6, so that patterns (not shown) corresponding to the plurality of figures included in the drawing data are drawn in the stripe frame STR2 of the workpiece M by the charged particle beam 10a1b. Then, similarly, patterns (not shown) corresponding to the plurality of figures included in the drawing data are drawn in the stripe frames STR3, STR4 to STRn of the workpiece M by the charged particle beam 10a1b.

In detail, in the example shown in FIG. 6, when the patterns PA1, PA2, PA3 are drawn in the stripe frame STR1 of the workpiece M by the charged particle beam 10a1b, the movable stage 10a2a (see FIG. 1) is controlled via the stage control circuit 10b6 (see FIG. 1) by the stage control portion 10b1i (see FIG. 2), so that the movable stage 10a2a is moved from the right side of FIG. 6 to the left side of FIG. 6. Then, before the patterns (not shown) are drawn in the stripe frame STR2 of the workpiece M by the charged particle beam 10a1b, the movable stage 10a2a (see FIG. 1) is controlled via the stage control circuit 10b6 (see FIG. 1) by the stage control portion 10b1i (see FIG. 2), so that the movable stage 10a2a is moved from an upper side of FIG. 6 to a lower side of FIG. 6.

Then, in the example shown in FIG. 6, when the patterns (not shown) are drawn in the stripe frame STR2 of the workpiece M by the charged particle beam 10a1b, the movable stage 10a2a (see FIG. 1) is controlled via the stage control circuit 10b6 (see FIG. 1) by the stage control portion 10b1i (see FIG. 2), so that the movable stage 10a2a is moved from the left side of FIG. 6 to the right side of FIG. 6.

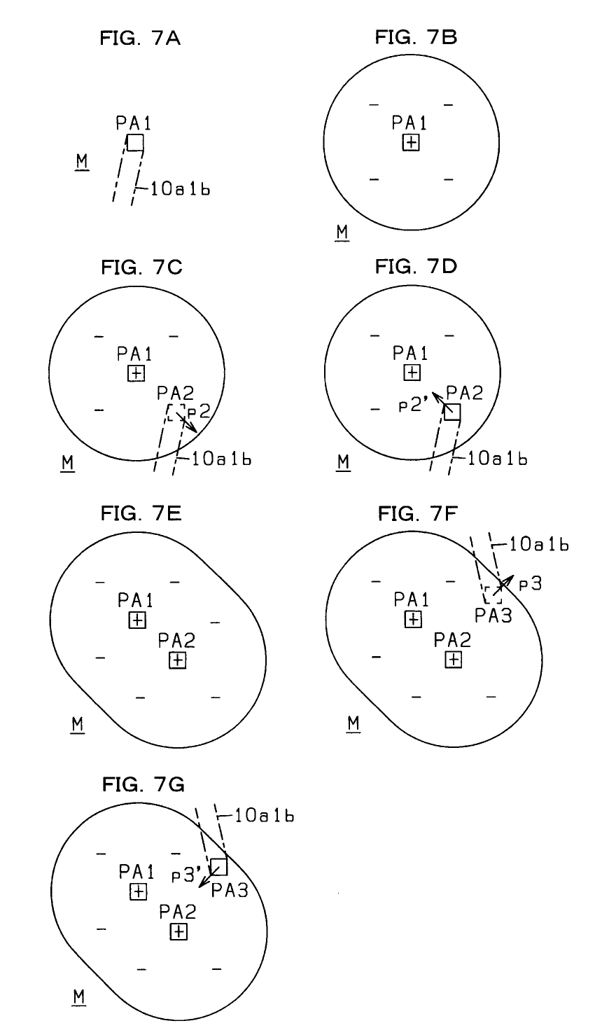

FIGS. 7A, 7B, 7C, 7D, 7E, 7F and 7G schematically explain an electrical charging of the resist caused by drawing the patterns PA1, PA2, PA3 shown in FIG. 6, the position deviation of the charged particle beam 10a1b, and an electrical charging effect correction process for cancelling the position deviation of the charged particle beam 10a1b.

In the example shown in FIGS. 7A, 7B, 7C, 7D, 7E, 7F and 7G, as shown in FIG. 7A, the pattern PA1 is a first pattern drawn on the resist of the workpiece M, so that the resist of the workpiece M is not electrically charged, when the charged particle beam 10a1b for drawing the pattern PA1 is applied to the resist of the workpiece M. Accordingly, the position deviation of the charged particle beam 10a1b for drawing the pattern PA1 does not occur, wherein the position deviation of the charged particle beam 10a1b is caused by the electrical charging effect of the resist of the workpiece M. Consequently, in the charged particle beam drawing apparatus 10 of the first embodiment, when the charged particle beam 10a1b for drawing the pattern PA1 is applied to the resist of the workpiece M, the charged particle beam 10a1b is precisely applied to a target position on the resist of the workpiece M without a correction of the position deviation of the charged particle beam 10a1b, then the pattern PA1 is precisely drawn in the target position on the resist of the workpiece M.

Then, in the example shown in FIGS. 7A, 7B, 7C, 7D, 7E, 7F and 7G, as shown in FIG. 7B, the resist of the workpiece M is electrically charged by the charged particle beam (electron beam in the example shown in FIGS. 7A, 7B, 7C, 7D, 7E, 7F and 7G) 10a1b (see FIG. 7A) applied to the resist of the workpiece M for drawing the pattern PA1 (see FIG. 7A). In detail, as shown in FIGS. 7A and 7B, an irradiation area of the resist of the workpiece M is positively charged, wherein the charged particle beam 10a1b for drawing the pattern PA1 is applied to the irradiation area, and a non-irradiation area of the resist of the workpiece M is negatively charged by fogging charged particles (fogging electrons), wherein the charged particle beam 10a1b for drawing the pattern PA1 is not applied to the non-irradiation area, and wherein the non-irradiation area is placed around the irradiation area.

Then, in the example shown in FIGS. 7A, 7B, 7C, 7D, 7E, 7F and 7G, as shown in FIGS. 7C and 7D, the charged particle beam 10a1b for drawing the pattern PA2 is applied to the resist of the workpiece M. In detail, the charged particle beam (electron beam) 10a1b for drawing the pattern PA2 is attracted by positive charges in the irradiation area which is positively charged, and the charged particle beam (electron beam) 10a1b for drawing the pattern PA2 is repelled by negative charges in the non-irradiation area which is negatively charged. Accordingly, in the example shown in FIGS. 7A, 7B, 7C, 7D, 7E, 7F and 7G, as shown in FIG. 7C, a position deviation p2 of the charged particle beam (electron beam) 10a1b for drawing the pattern PA2 occurs, wherein the position deviation p2 of the charged particle beam (electron beam) 10a1b is caused by the electrical charging effect of the resist of the workpiece M. Therefore, in the charged particle beam drawing apparatus 10 of the first embodiment, as shown in FIG. 7D, the charged particle beam (electron beam) 10a1b is deflected to a direction of an arrow p2′ by the main deflector 10a1f (see FIG. 1), in order to correct the position deviation p2 of the charged particle beam (electron beam) 10a1b caused by the electrical charging effect of the resist of the workpiece M, wherein the direction of the arrow p2′ is opposite to a direction of the position deviation p2 (see FIG. 7C). Consequently, in the charged particle beam drawing apparatus 10 of the first embodiment, the charged particle beam 10a1b for drawing the pattern PA2 can be precisely applied to a target position on the resist of the workpiece M, then the pattern PA2 can be precisely drawn in the target position on the resist of the workpiece M.

In detail, as time passes, the electrical charging of the irradiation area of the charged particle beam (electron beam) 10a1b (see FIG. 7A) for drawing the pattern PA1 (see FIG. 7A) is attenuated. Accordingly, in the charged particle beam drawing apparatus 10 of the first embodiment, an irradiation time T1 of the charged particle beam 10a1b for drawing the pattern PA1 is calculated by an irradiation time calculating portion 10b1b5 (see FIG. 3). Also, an elapsed time t2 is calculated by an elapsed time calculating portion 10b1b6 (see FIG. 3), wherein the elapsed time t2 means an irradiation time T2 of the charged particle beam 10a1b (see FIG. 7D) for drawing the pattern PA2 (see FIG. 7D). In the charged particle beam drawing apparatus 10 of the first embodiment, as shown in FIG. 7D, when the position deviation p2 (see FIG. 7C) of the charged particle beam (electron beam) 10a1b caused by the electrical charging effect of the resist of the workpiece M is corrected, an attenuation of the electrical charging of the irradiation area of the charged particle beam (electron beam) 10a1b (see FIG. 7A) is considered, on the basis of time (T2-T1) from the irradiation of the charged particle beam 10a1b (see FIG. 7A) for drawing the pattern PA1 (see FIG. 7A) to the irradiation of the charged particle beam 10a1b (see FIG. 7D) for drawing the pattern PA2 (see FIG. 7D).

Then, in the example shown in FIGS. 7A, 7B, 7C, 7D, 7E, 7F and 7G, as shown in FIG. 7E, the resist of the workpiece M is electrically charged by the charged particle beam (electron beam) 10a1b (see FIG. 7A) for drawing the pattern PA1 (see FIG. 7A) and the charged particle beam (electron beam) 10a1b (see FIG. 7D) for drawing the pattern PA2 (see FIG. 7D). In detail, as shown in FIG. 7D, when the charged particle beam (electron beam) 10a1b for drawing the pattern PA2 is applied to the resist of the workpiece M, the resist becomes electrically conductive for a moment, which is called EBIC (electron beam induced conductivity). Concretely, when the charged particle beam (electron beam) 10a1b (see FIG. 7A) for drawing the pattern PA1 (see FIG. 7A) is applied to the resist of the workpiece M, fogging charged particles (fogging electrons) are accumulated in the irradiation area of the charged particle beam (electron beam) 10a1b (see FIG. 7D) for drawing the pattern PA2 (see FIG. 7D) on the resist of the workpiece M, and then, when the charged particle beam (electron beam) 10a1b (see FIG. 7D) for drawing the pattern PA2 (see FIG. 7D) is applied to the resist of the workpiece M, the fogging charged particles (fogging electrons) accumulated in the irradiation area of the charged particle beam (electron beam) 10a1b (see FIG. 7D) for drawing the pattern PA2 (see FIG. 7D) are moved from the resist of the workpiece M to a substrate of the workpiece M, so that the electrical charging in the irradiation area of the charged particle beam (electron beam) 10a1b (see FIG. 7D) for drawing the pattern PA2 (see FIG. 7D) on the resist of the workpiece M is reset. Consequently, as shown in FIG. 7E, the irradiation area of the charged particle beam (electron beam) 10a1b (see FIG. 7D) for drawing the pattern PA2 (see FIG. 7D) on the resist of the workpiece M is positively charged, after the charged particle beam (electron beam) 10a1b (see FIG. 7D) for drawing the pattern PA2 (see FIG. 7D) is applied to the resist of the workpiece M. As shown in FIG. 7E, the non-irradiation area of the charged particle beam (electron beam) 10a1b (see FIG. 7D) for drawing the pattern PA2 (see FIGS. 7D and 7E) on the resist of the workpiece M is negatively charged by the fogging charged particles (fogging electrons) which are accumulated when the charged particle beam (electron beam) 10a1b (see FIG. 7A) for drawing the pattern PA1 (see FIG. 7A) is applied, and fogging charged particles (fogging electrons) which are accumulated when the charged particle beam (electron beam) 10a1b (see FIG. 7D) for drawing the pattern PA2 (see FIGS. 7D and 7E) is applied, wherein the non-irradiation area of the charged particle beam (electron beam) 10a1b (see FIG. 7D) for drawing the pattern PA2 (see FIGS. 7D and 7E) is placed around the irradiation area of the charged particle beam (electron beam) 10a1b (see FIG. 7D) for drawing the pattern PA2 (see FIGS. 7D and 7E).

Then, in the example shown in FIGS. 7A, 7B, 7C, 7D, 7E, 7F and 7G, as shown in FIGS. 7F and 7G, the charged particle beam (electron beam) 10a1b (see FIGS. 7F and 7G) for drawing the pattern PA3 (see FIGS. 7F and 7G) is applied to the resist of the workpiece M. In detail, the charged particle beam (electron beam) 10a1b (see FIG. 7F) for drawing the pattern PA3 (see FIG. 7F) is attracted by positive charges in the irradiation areas which are positively charged, and the charged particle beam (electron beam) 10a1b (see FIG. 7F) for drawing the pattern PA3 (see FIG. 7F) is repelled by negative charges in the non-irradiation area which is negatively charged. Accordingly, in the example shown in FIGS. 7A, 7B, 7C, 7D, 7E, 7F and 7G, as shown in FIG. 7F, a position deviation p3 of the charged particle beam (electron beam) 10a1b (see FIG. 7F) for drawing the pattern PA3 (see FIG. 7F) occurs, wherein the position deviation p3 of the charged particle beam (electron beam) 10a1b (see FIG. 7F) is caused by the electrical charging effect of the resist of the workpiece M. Therefore, in the charged particle beam drawing apparatus 10 of the first embodiment, as shown in FIG. 7G, the charged particle beam (electron beam) 10a1b is deflected to a direction of an arrow p3′ by the main deflector 10a1f (see FIG. 1), in order to correct the position deviation p3 of the charged particle beam (electron beam) 10a1b caused by the electrical charging effect of the resist of the workpiece M, wherein the direction of the arrow p3′ is opposite to a direction of the position deviation p3 (see FIG. 7F). Consequently, in the charged particle beam drawing apparatus 10 of the first embodiment, the charged particle beam 10a1b (see FIG. 7G) for drawing the pattern PA3 (see FIG. 7G) can be precisely applied to a target position on the resist of the workpiece M, then the pattern PA3 (see FIG. 7G) can be precisely drawn in the target position on the resist of the workpiece M.

In detail, as time passes, the electrical charging of the irradiation area of the charged particle beam (electron beam) 10a1b (see FIG. 7A) for drawing the pattern PA1 (see FIG. 7A) and the electrical charging of the irradiation area of the charged particle beam (electron beam) 10a1b (see FIG. 7D) for drawing the pattern PA2 (see FIG. 7D) are attenuated. Accordingly, in the charged particle beam drawing apparatus 10 of the first embodiment, the irradiation time T1 of the charged particle beam 10a1b (see FIG. 7A) for drawing the pattern PA1 (see FIG. 7A) and the irradiation time T2 of the charged particle beam 10a1b (see FIG. 7D) for drawing the pattern PA2 (see FIG. 7D) are calculated by the irradiation time calculating portion 10b1b5 (see FIG. 3). Also, an elapsed time t3 is calculated by the elapsed time calculating portion 10b16 (see FIG. 3), wherein the elapsed time t3 means an irradiation time T3 of the charged particle beam 10a1b (see FIG. 7G) for drawing the pattern PA3 (see FIG. 7G). In the charged particle beam drawing apparatus 10 of the first embodiment, as shown in FIG. 7G, when the position deviation p3 (see FIG. 7F) of the charged particle beam (electron beam) 10a1b (see FIG. 7F) caused by the electrical charging effect of the resist of the workpiece M is corrected, an attenuation of the electrical charging of the irradiation area of the charged particle beam (electron beam) 10a1b (see FIG. 7A) is considered, on the basis of time (T3-T1) from the irradiation of the charged particle beam 10a1b (see FIG. 7A) for drawing the pattern PA1 (see FIG. 7A) to the irradiation of the charged particle beam 10a1b (see FIG. 7G) for drawing the pattern PA3 (see FIG. 7G), and an attenuation of the electrical charging of the irradiation area of the charged particle beam (electron beam) 10a1b (see FIG. 7D) is considered, on the basis of time (T3-T2) from the irradiation of the charged particle beam 10a1b (see FIG. 7D) for drawing the pattern PA2 (see FIG. 7D) to the irradiation of the charged particle beam 10a1b (see FIG. 7G) for drawing the pattern PA3 (see FIG. 7G).

In the charged particle beam drawing apparatus 10 of the first embodiment, an electrical charging effect correction process which is explained by referring to FIGS. 7A, 7B, 7C, 7D, 7E, 7F and 7G, is performed in accordance with a sequence of shots of the charged particle beam 10a1b (see FIG. 6) applied to the resist in the drawing area DA (see FIG. 6) of the workpiece M (see FIG. 6), and the electrical charging effect correction process is continued until a last shot of the charged particle beam 10a1b (see FIG. 6) applied to the resist in the drawing area DA (see FIG. 6) of the workpiece M (see FIG. 6) is completed. Consequently, in the charged particle beam drawing apparatus 10 of the first embodiment, all of the patterns PA1, PA2, PA3 (see FIG. 6) can be precisely drawn in target positions on the resist in the drawing area DA (see FIG. 6) of the workpiece M (see FIG. 6).

An object of the charged particle beam drawing apparatus 10 of the first embodiment is to perform the electrical charging effect correction process by an online process, wherein the electrical charging effect correction process is explained by referring to FIGS. 7A, 7B, 7C, 7D, 7E, 7F, 7G. Concretely, the object of the charged particle beam drawing apparatus 10 of the first embodiment is to complete a calculation of a position deviation amount of the charged particle beam (electron beam) 10a1b (see FIG. 6), after the drawing data is input to the control computer 10b1 (see FIGS. 1 and 2) of the control portion 10b (see FIG. 1) and before a preparation for a first irradiation of the charged particle beam 10a1b (see FIG. 6) is completed, wherein the position deviation amount means a direction and an amount of the position deviation p2, p3 (see FIGS. 7C and 7F). In the charged particle beam drawing apparatus 10 of the first embodiment, in order to achieve the object, following steps are taken to decrease a processing time in the electrical charging effect correction processing portion 10b1b (see FIGS. 2 and 3).

In detail, in the charged particle beam drawing apparatus 10 of the first embodiment, the drawing data input by the input portion 10b1a (see FIG. 2) is transferred to the electrical charging effect correction processing portion 10b1b (see FIGS. 2 and 3), and then, an initialization is performed. Namely, a value of a pattern area density distribution ρ(x,y) is changed to zero by a pattern area density distribution calculating portion 10b1b1 (see FIG. 3), a value of a dose distribution D(x,y) is changed to zero by a dose distribution calculating portion 10b1b2 (see FIG. 3), a value of an irradiation amount distribution E(x,y) is changed to zero by an irradiation amount distribution calculating portion 10b1b3 (see FIG. 3), a value of a fogging charged particle amount distribution (fogging electron amount distribution) F(x,y) is changed to zero by a fogging charged particle amount distribution calculating portion 10b1b4 (see FIG. 3), a value of the irradiation time T is changed to zero by the irradiation time calculating portion 10b1b5 (see FIG. 3), and a value of the elapsed time t is changed to zero by the elapsed time calculating portion 10b1b6 (see FIG. 3).

Then, in the charged particle beam drawing apparatus 10 of the first embodiment, the pattern area density distribution ρ(x,y) of patterns PA1, PA2, PA3 etc. drawn in the stripe frame STR1 (see FIG. 6) in the drawing area DA (see FIG. 6) of the workpiece M (see FIG. 6) by the charged particle beam 10a1b (see FIG. 6) is calculated by means of the pattern area density distribution calculating portion 10b1b1 (see FIG. 3), on the basis of the drawing data, by using a central processing unit (CPU) 10b1b9 (see FIG. 3). And then, the value of the pattern area density distribution ρ(x,y) in the stripe frame STR1 (see FIG. 6) is added to zero, which is equal to the value of the pattern area density distribution ρ(x,y) when the initialization is performed.

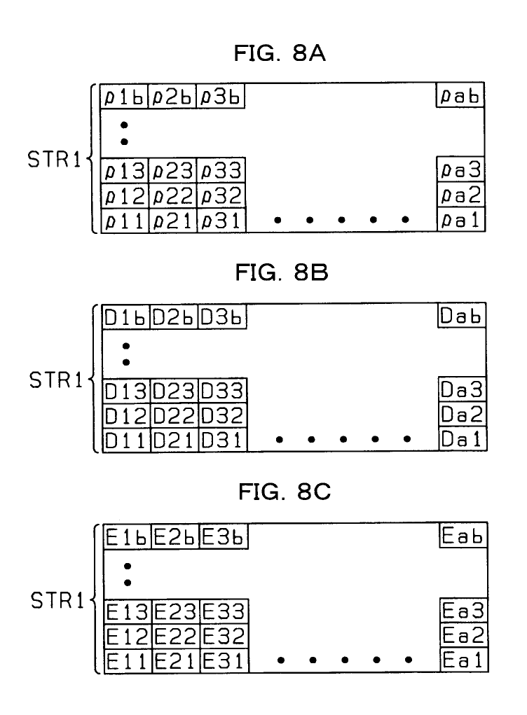

FIG. 8A is a pattern area density distribution map which shows the value of the pattern area density distribution ρ(x,y) in the stripe frame STR1 (see FIG. 6) in the drawing area DA (see FIG. 6) of the workpiece M (see FIG. 6). In the example shown in FIG. 8A, the stripe frame STR1 is divided into meshes, wherein the stripe frame STR1 is composed of meshes in b rows of a, namely the number of the meshes in the stripe frame STR1 is (a×b).

Then, in the charged particle beam drawing apparatus 10 of the first embodiment, the dose distribution D(x,y) is calculated by means of the dose distribution calculating portion 10b1b2 (see FIG. 3), on the basis of the pattern area density distribution ρ(x,y) in the stripe frame STR1 (see FIG. 6) in the drawing area DA (see FIG. 6) of the workpiece M (see FIG. 6) and a backscattering ratio η of charged particles (electrons) in the resist, by using the central processing unit (CPU) 10b1b9 (see FIG. 3). In detail, a calculation of a following equation is performed by the central processing unit (CPU) 10b1b9 (see FIG. 3). And then, the value of the dose distribution D(x,y) in the stripe frame STR1 (see FIG. 6) is added to zero, which is equal to the value of the dose distribution D(x,y) when the initialization is performed.

D(x,y)=D₀×(1+2×η)/(1+2×η×ρ(x,y))

where D₀ is a base dose.

FIG. 8B is a dose distribution map which shows the value of the dose distribution D(x,y) in the stripe frame STR1 (see FIG. 6) in the drawing area DA (see FIG. 6) of the workpiece M (see FIG. 6). In the example shown in FIG. 8B, the stripe frame STR1 is divided into meshes, wherein the stripe frame STR1 is composed of meshes in b rows of a, namely the number of the meshes in the stripe frame STR1 is (a×b).

Then, in the charged particle beam drawing apparatus 10 of the first embodiment, the irradiation amount distribution E(x,y) which is a product of the pattern area density distribution ρ(x,y) by the dose distribution D(x,y) is calculated by means of the irradiation amount distribution calculating portion 10b1b3 (see FIG. 3), by using the central processing unit (CPU) 10b1b9 (see FIG. 3). And then, the value of the irradiation amount distribution E(x,y) in the stripe frame STR1 (see FIG. 6) is added to zero, which is equal to the value of the irradiation amount distribution E(x,y) when the initialization is performed.

FIG. 8C is an irradiation amount distribution map which shows the value of the irradiation amount distribution E(x,y) in the stripe frame STR1 (see FIG. 6) in the drawing area DA (see FIG. 6) of the workpiece M (see FIG. 6). In the example shown in FIG. 8C, the stripe frame STR1 is divided into meshes, wherein the stripe frame STR1 is composed of meshes in b rows of a, namely the number of the meshes in the stripe frame STR1 is (a×b).

Then, in the charged particle beam drawing apparatus 10 of the first embodiment, a convolution calculation of the irradiation amount distribution E(x,y) and a fogging charged particle distribution (fogging electron distribution) g(x,y) is performed by means of the fogging charged particle amount distribution calculating portion 10b1b4 (see FIG. 4), by using a high speed processing unit 10b1b10 (see FIG. 3), such as a GPU (graphics processing unit), wherein a processing speed of the high speed processing unit 10b1b10 (see FIG. 3) is higher than a processing speed of the central processing unit (CPU) 10b1b9 (see FIG. 3). So that a fogging charged particle amount distribution (fogging electron amount distribution) F(x,y) is calculated. In detail, in the charged particle beam drawing apparatus 10 of the first embodiment, a calculation of the high speed processing unit 10b1b10 (see FIG. 3) is performed in parallel with a calculation of the central processing unit (CPU) 10b1b9 (see FIG. 3). And then, the value of the fogging charged particle amount distribution (fogging electron amount distribution) F(x,y) which is calculated by the high speed processing unit 10b1b10 (see FIG. 3) is added to zero, which is equal to the value of the fogging charged particle amount distribution (fogging electron amount distribution) F(x,y) when the initialization is performed.

In detail, in the charged particle beam drawing apparatus 10 of the first embodiment, Gaussian distribution (normal distribution) is used as the fogging charged particle distribution (fogging electron distribution) g(x,y). A following equation shows the fogging charged particle distribution (fogging electron distribution) g(x,y).

g(x,y)=(1/πσ²)×exp(−(x²+y²)/σ²)

where σ is a fogging scattering radius which means a standard deviation of the normal distribution.

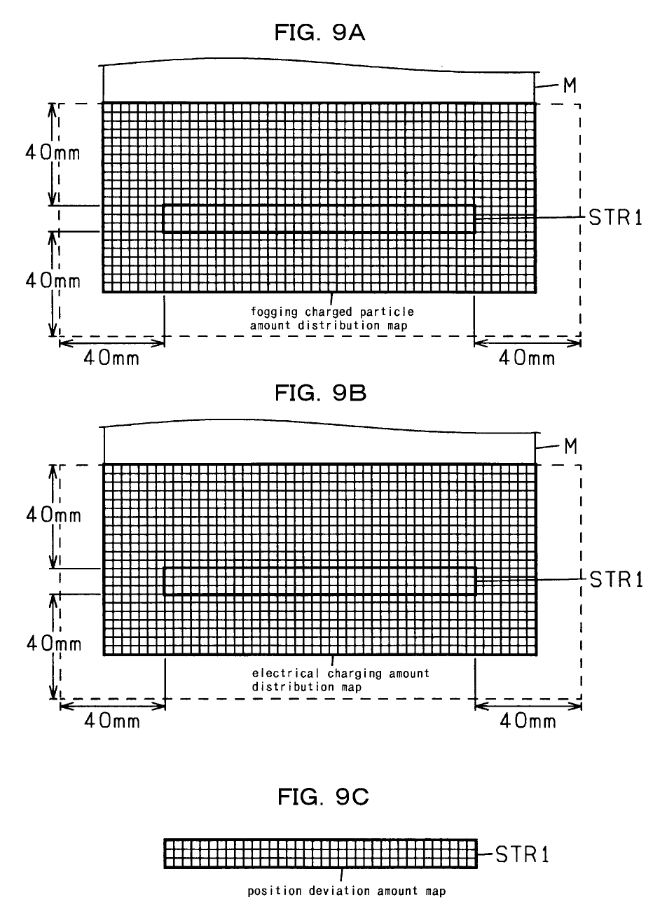

FIG. 9A is a fogging charged particle amount distribution map which shows the value of the fogging charged particle amount distribution (fogging electron amount distribution) F(x,y) when the convolution calculation of the irradiation amount distribution E(x,y) and the fogging charged particle distribution (fogging electron distribution) g(x,y) is completed in all of the stripe frame STR1 (see FIG. 6) in the drawing area DA (see FIG. 6) of the workpiece M (see FIG. 6), namely when all of irradiations of the charged particle beam 10a1b (see FIG. 6) in the stripe frame STR1 (see FIG. 6) are completed. An influence of the electrical charging effect should be considered within 40 mm radius of an irradiation position of the charged particle beam 10a1b (see FIG. 6). Accordingly, in the example shown in FIG. 9A, the fogging charged particle amount distribution map which has an upper side, a lower side, a left side and a right side is rectangular, wherein the upper side of the fogging charged particle amount distribution map is 40 mm upper than an upper end of the stripe frame STR1, the lower side of the fogging charged particle amount distribution map corresponds to a lower end of the workpiece M, the left side of the fogging charged particle amount distribution map corresponds to a left end of the workpiece M, and the right side of the fogging charged particle amount distribution map corresponds to a right end of the workpiece M.

In the charged particle beam drawing apparatus 10 of the first embodiment, the irradiation time T of the charged particle beam 10a1b (see FIG. 6) for drawing the patterns PA1, PA2, PA3 etc. (see FIG. 6) is calculated by means of the irradiation time calculating portion 10b1b5 (see FIG. 3) by using the central processing unit (CPU) 10b1b9 (see FIG. 3), in parallel with a calculation process in the high speed processing unit 10b1b10 (see FIG. 3).

In the charged particle beam drawing apparatus 10 of the first embodiment, the elapsed time t is calculated by means of the elapsed time calculating portion 10b1b6 (see FIG. 3) by using the central processing unit (CPU) 10b1b9 (see FIG. 3), in parallel with the calculation process in the high speed processing unit 10b1b10 (see FIG. 3), wherein the elapsed time t is necessary to consider the attenuation of the electrical charging which is explained by referring to FIGS. 7A, 7B, 7C, 7D, 7E, 7F and 7G.

In the charged particle beam drawing apparatus 10 of the first embodiment, an electrical charging amount distribution C(x,y) of the resist of the workpiece M (see FIG. 6) is calculated by means of an electrical charging amount distribution calculating portion 10b1b7 (see FIG. 3) by using the central processing unit (CPU) 10b1b9 (see FIG. 3), in parallel with the calculation process in the high speed processing unit 10b1b10 (see FIG. 3), wherein the resist of the workpiece M (see FIG. 6) is electrically charged by the irradiation of the charged particle beam 10a1b (see FIG. 6). In detail, in the charged particle beam drawing apparatus 10 of the first embodiment, an electrical charging amount distribution Cf(x,y) in the non-irradiation area of the charged particle beam 10a1b is calculated on the basis of a following equation.

Cf(x,y)=fᵢ×F+f₂×F²+f₃×F³

where f₁ is a constant, f₂ is a constant, f₃ is a constant, F corresponds to the fogging charged particle amount distribution F(x,y) calculated by the fogging charged particle amount distribution calculating portion 10b1b4 (see FIG. 3).

In the charged particle beam drawing apparatus 10 of the first embodiment, an electrical charging amount distribution Ce(x,y) in the irradiation area of the charged particle beam 10a1b is calculated on the basis of following equations (1), (2), (3).

Ce(x,y)=d₀+d₁×ρ+d₂×D+d₃×E+e₁×F+e₂×F²+e₃×F³+κ(ρ)×exp(−(t−T)/λ(ρ)) (1)

κ(ρ)=κ₀+κ₁×ρ+κ₂×ρ² (2)

λ(ρ)=λ₀+λ₁×ρ+λ₂×ρ² (3)

where d₀ is a constant, d₁ is a constant, ρ is the pattern area density distribution ρ(x,y) calculated by the pattern area density distribution calculating portion 10b1b1 (see FIG. 3), d₂ is a constant, D is the dose amount distribution D(x,y) calculated by the dose amount distribution calculating portion 10b1b2 (see FIG. 3), d₃ is a constant, E is the irradiation amount distribution E(x,y) calculated by the irradiation amount distribution calculating portion 10b1b3 (see FIG. 3), e₁ is a constant, e₂ is a constant, e₃ is a constant, κ(ρ) is an electrical charging attenuation amount, κ₀ is a constant, κ₁ is a constant, κ₂ is a constant, λ(ρ) is an electrical charging attenuation time constant, λ₀ is a constant, λ₁ is a constant, and λ₂ is a constant.

In detail, in the charged particle beam drawing apparatus 10 of the first embodiment, it is considered that the electrical charging attenuation amount κ(ρ) decreases if the pattern area density distribution ρ decreases, and the electrical charging is attenuated faster if the pattern area density distribution ρ decreases. In the charged particle beam drawing apparatus 10 of the first embodiment, the electrical charging amount distribution C(x,y) is calculated as a union (Ce(x,y) U Cf(x,y)) of the electrical charging amount distribution Cf(x,y) in the non-irradiation area of the charged particle beam 10a1b (see FIG. 6) and the electrical charging amount distribution Ce(x,y) in the irradiation area of the charged particle beam 10a1b (see FIG. 6).

FIG. 9B is an electrical charging amount distribution map which shows a value of the electrical charging amount distribution C(x,y) when the fogging charged particle amount distribution map in all of the stripe frame STR1 (see FIG. 6) in the drawing area DA (see FIG. 6) of the workpiece M (see FIG. 6) shown in FIG. 9A is formed, namely when all of irradiations of the charged particle beam 10a1b (see FIG. 6) in the stripe frame STR1 (see FIG. 6) are completed. The influence of the electrical charging effect should be considered within 40 mm radius of the irradiation position of the charged particle beam 10a1b (see FIG. 6). Accordingly, in the example shown in FIG. 9B, similar to the example shown in FIG. 9A, the electrical charging amount distribution map which has an upper side, a lower side, a left side and a right side is rectangular, wherein the upper side of the electrical charging amount distribution map is 40 mm upper than the upper end of the stripe frame STR1, the lower side of the electrical charging amount distribution map corresponds to the lower end of the workpiece M, the left side of the electrical charging amount distribution map corresponds to the left end of the workpiece M, and the right side of the electrical charging amount distribution map corresponds to the right end of the workpiece M.

Then, in the charged particle beam drawing apparatus 10 of the first embodiment, a convolution calculation of the electrical charging amount distribution C(x,y) and a position deviation response function r(x,y) is performed by means of a position deviation amount map calculating portion 10b1b8 (see FIG. 4), by using the high speed processing unit 10b1b10 (see FIG. 3). So that the position deviation amount map p(x,y) is calculated. In detail, in the charged particle beam drawing apparatus 10 of the first embodiment, the calculation of the high speed processing unit 10b1b10 (see FIG. 3) is performed in parallel with the calculation of the central processing unit (CPU) 10b1b9 (see FIG. 3). FIG. 9C is the position deviation amount map p(x,y) in all of the stripe frame STR1 (see FIG. 6) in the drawing area DA (see FIG. 6) of the workpiece M (see FIG. 6).

As mentioned before, FIG. 9A shows the fogging charged particle amount distribution map at the time when all of irradiations of the charged particle beam 10a1b (see FIG. 6) in the stripe frame STR1 (see FIG. 6) are completed, and FIG. 9B shows the electrical charging amount distribution map at the time when all of irradiations of the charged particle beam 10a1b (see FIG. 6) in the stripe frame STR1 (see FIG. 6) are completed. As explained before by referring to FIGS. 7A, 7B, 7C, 7D, 7E, 7F, and 7G, the fogging charged particle amount distribution (fogging electron amount distribution) F(x,y) and the electrical charging amount distribution C(x,y) changes, if one shot (irradiation) of the charged particle beam 10a1b (see FIGS. 7A, 7D, 7G) is performed. Consequently, preferably, every time one shot (irradiation) of the charged particle beam 10a1b (see FIG. 6) is performed, the fogging charged particle amount distribution (fogging electron amount distribution) F(x,y) is calculated by the fogging charged particle amount distribution calculating portion 10b1b4 (see FIG. 3), the electrical charging amount distribution C(x,y) is calculated by the electrical charging amount distribution calculating portion 10b1b7 (see FIG. 3), and the position deviation p2, p3 (see FIGS. 7C and 7F) of the charged particle beam 10a1b (see FIGS. 7C and 7F) is calculated by the position deviation amount map calculating portion 10b1b8 (see FIG. 3).

As mentioned before by referring to FIGS. 8A, 8B, 8C, 9A, 9B and 9B, the position deviation amount map p(x,y) (see FIG. 9C) in all of the stripe frame STR1 (see FIG. 6) in the drawing area DA (see FIG. 6) of the workpiece M (see FIG. 6) is formed. And then, in the charged particle beam drawing apparatus 10 of the first embodiment, similar process is performed with respect to the stripe frames STR2, STR3, STR4 to STRn, so that the position deviation amount map p(x,y) in all of the drawing area DA (see FIG. 6) of the workpiece M (see FIG. 6) is formed.

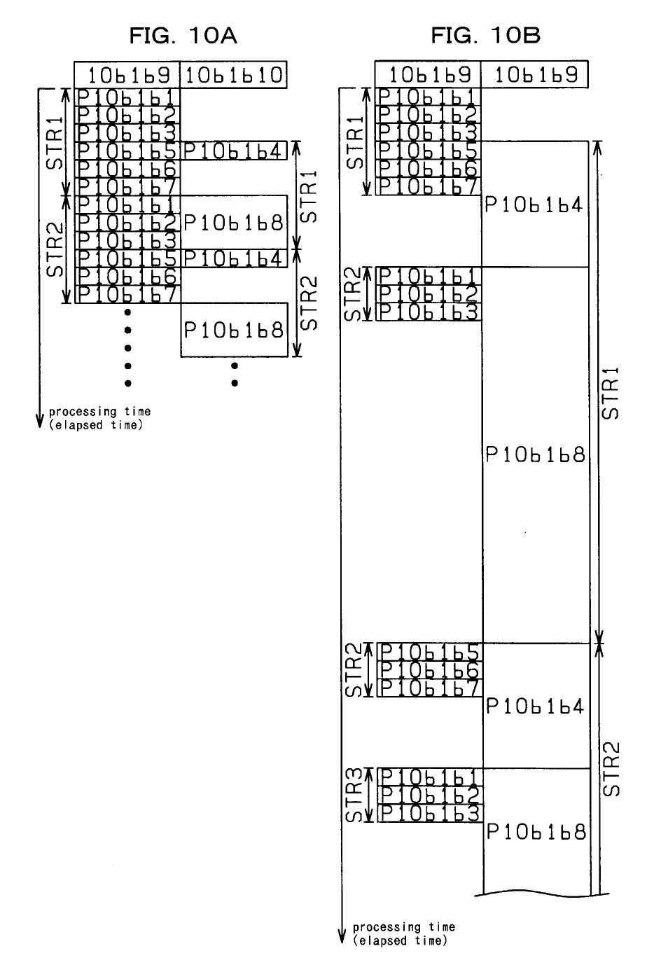

FIG. 10A shows the processing time (elapsed time) of the electrical charging effect correction process in the charged particle beam drawing apparatus 10 of the first embodiment, wherein a calculating process is performed in parallel by the central processing unit (CPU) 10b1b9 (see FIG. 3) and the high speed processing unit 10b1b10 (see FIG. 3), wherein the processing speed of the high speed processing unit 10b1b10 (see FIG. 3) is higher than the processing speed of the central processing unit (CPU) 10b1b9 (see FIG. 3). FIG. 10B shows the processing time (elapsed time) of the electrical charging effect correction process in a typical charged particle beam drawing apparatus, wherein the calculating process is performed in parallel by two central processing units (CPUs), wherein the processing speed of each of the two central processing units (CPUs) is same as the processing speed of the central processing unit (CPU) 10b1b9 (see FIG. 3).

In the charged particle beam drawing apparatus 10 of the first embodiment, as shown in FIG. 10A, the central processing unit (CPU) 10b1b9 (see FIGS. 3 and 10A) is used for the calculation P10b1b1 in the pattern area density distribution calculating portion 10b1b1 (see FIG. 3), the calculation P10b1b2 in the dose distribution calculating portion 10b1b2 (see FIG. 3), the calculation P10b1b3 in the irradiation amount distribution calculating portion 10b1b3 (see FIG. 3), the calculation P10b1b5 in the irradiation time calculating portion 10b1b5 (see FIG. 3), the calculation P10b1b6 in the elapsed time calculating portion 10b1b6 (see FIG. 3) and the calculation P10b1b7 in the electrical charging amount distribution calculating portion 10b1b7 (see FIG. 3). The high speed processing unit 10b1b10 (see FIGS. 3 and 10A) is used for the calculation P10b1b4 in the fogging charged particle amount distribution calculating portion 10b1b4 (see FIG. 3) and the calculation P10b1b8 in the position deviation amount map calculating portion 10b1b8 (see FIG. 4), wherein the processing speed of the high speed processing unit 10b1b10 (see FIGS. 3 and 10A) is higher than the processing speed of the central processing unit (CPU) 10b1b9 (see FIGS. 3 and 10A).

In other words, in the charged particle beam drawing apparatus 10 of the first embodiment, as shown in FIG. 10A, the calculations P10b1b1, P10b1b2, P10b1b3, P10b1b4, P10b1b5, P10b1b6, P10b1b7, P10b1b8 which are necessary for the electrical charging effect correction process are performed in parallel by the central processing unit (CPU) 10b1b9 and the high speed processing unit 10b1b10, wherein the processing speed of the high speed processing unit 10b1b10 is higher than the processing speed of the central processing unit (CPU) 10b1b9. Consequently, in the charged particle beam drawing apparatus 10 of the first embodiment, the processing time for performing the electrical charging effect correction process can be shorter than a case (not shown) in which the high speed processing unit 10b1b10 is not provided, and the calculations P10b1b1, P10b1b2, P10b1b3, P10b1b4, P10b1b5, P10b1b6, P10b1b7, P10b1b8 for the electrical charging effect correction process are performed by only the central processing unit 10b1b9, and another case (see FIG. 10B) in which the calculations P10b1b1, P10b1b2, P10b1b3, P10b1b4, P10b1b5, P10b1b6, P10b1b7, P10b1b8 for the electrical charging effect correction process are performed in parallel by the central processing unit 10b1b9 and another processing unit which has the same processing speed as the central processing unit 10b1b9. Further, in the charged particle beam drawing apparatus 10 of the first embodiment, the electrical charging effect correction process can be precisely performed.

Particularly, in the charged particle beam drawing apparatus 10 of the first embodiment, as shown in FIG. 10A, the calculations P10b1b4, P10b1b8 are performed by using the high speed processing unit 10b1b10, wherein the processing load of the calculations P10b1b4, P10b1b8 is extremely larger than the processing load of another calculations P10b1b1, P10b1b2, P10b1b3, P10b1b5, P10b1b6, P10b1b7, and wherein the processing speed of the high speed processing unit 10b1b10 is higher than the processing speed of the central processing unit (CPU) 10b1b9. Accordingly, in the charged particle beam drawing apparatus 10 of the first embodiment, the processing time of the calculations P10b1b4, P10b1b8 can be decreased, so that the electrical charging effect correction process can be performed by the online process.

In detail, when Japanese Patent Application No. 2009-264543 is filed in Japan, a central processing unit (CPU) which has sufficiently high processing speed, and which can be mounted on a control circuit board of the charged particle beam drawing apparatus 10, does not exist. Consequently, in the charged particle beam drawing apparatus 10 of the first embodiment, preferably, a non-mount type GPU (graphics processing unit) is used as the high speed processing unit 10b1b10 (see FIG. 3), wherein the processing speed of the GPU is higher than the processing speed of the central processing unit (CPU) 10b1b9 (see FIG. 3) which can be mounted on the control circuit board of the charged particle beam drawing apparatus 10, and wherein the non-mount type GPU is not mounted on the control circuit board of the charged particle beam drawing apparatus 10. Namely, the high speed processing unit 10b1b10 (see FIG. 3) is constituted by an outer high speed processing unit which is placed out of the control circuit board. If a chip type high speed processor is developed in future, the high speed processing unit 10b1b10 (see FIG. 3) can be constituted by the chip type high speed processor, wherein the chip type high speed processor can be mounted on the control circuit board of the charged particle beam drawing apparatus 10, and wherein the processing speed of the chip type high speed processor is higher than the processing speed of the central processing unit (CPU) 10b1b9 (see FIG. 3).

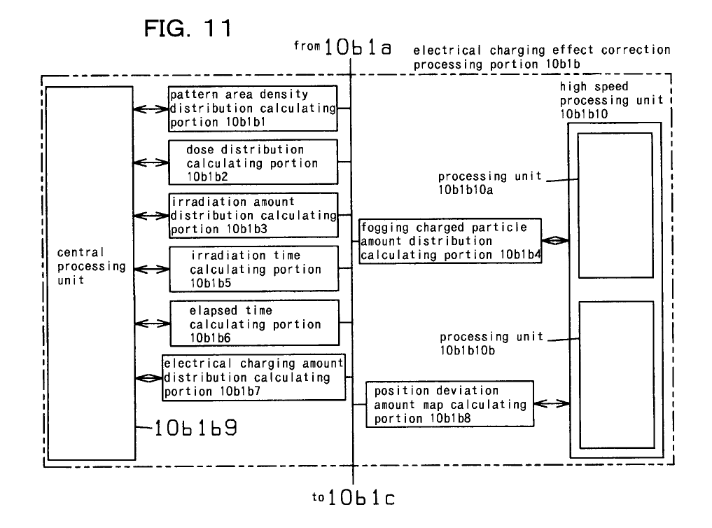

FIG. 11 shows the electrical charging effect correction processing portion 10b1b of the charged particle beam drawing apparatus 10 of a third embodiment, in detail. The charged particle beam drawing apparatus 10 of the third embodiment is different from the charged particle beam drawing apparatus 10 of the first embodiment. Particularly, in the charged particle beam drawing apparatus 10 of the third embodiment, as shown in FIG. 11, two processing units 10b1b10a, 10b1b10b are provided with the high speed processing unit 10b1b10, wherein each processing unit 10b1b10a, 10b1b10b is a non-mount type processing unit, such as the GPU (graphics processing unit), and wherein each processing unit 10b1b10a, 10b1b10b is not mounted on the control circuit board of the charged particle beam drawing apparatus 10.

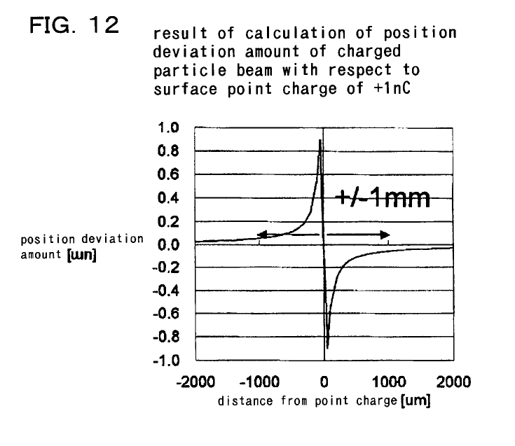

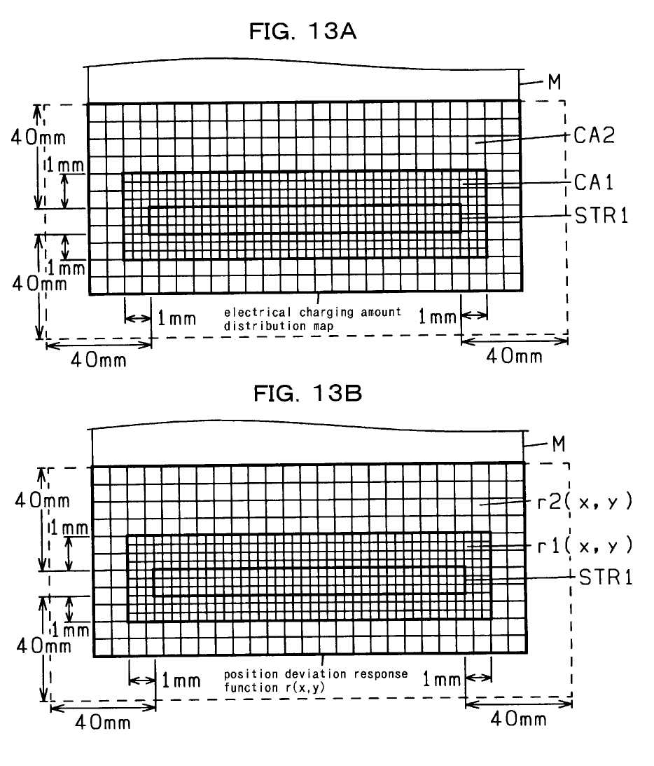

FIG. 12 is a graph showing a result of a calculation of the position deviation amount of the charged particle beam with respect to a surface point electric charge of +1 nC. As shown in FIG. 12, the inventors discovered in their research that the position deviation amount of the charged particle beam 10a1b applied to a first position wherein a distance from the first position to the point electric charge is equal to or larger than 1 mm, is considerably smaller than the position deviation amount of the charged particle beam 10a1b applied to a second position wherein a distance from the second position to the point electric charge is smaller than 1 mm. Also, the inventors discovered in their research that the electrical charging effect correction process can precisely be performed, even if an electrical charging amount distribution map (see FIG. 13A) has meshes of large size, wherein the meshes of large size are separated from the electric charge. Consequently, in the charged particle beam drawing apparatus 10 of the third embodiment, the electrical charging amount distribution map (see FIG. 13A) calculated by the electrical charging amount distribution calculating portion 10b1b7 (see FIG. 11) has a first electrical charging area CA1 (see FIG. 13A) and a second electrical charging area CA2 (see FIG. 13A), wherein size of the meshes in the second electrical charging area CA2 (see FIG. 13A) is larger than size of meshes in the first electrical charging area CA1 (see FIG. 13A).

FIG. 13A is an electrical charging amount distribution map of the charged particle beam drawing apparatus 10 of the third embodiment at the time when all of irradiations of the charged particle beam 10a1b (see FIG. 6) in the stripe frame STR1 (see FIG. 6) in the drawing area DA (see FIG. 6) of the workpiece M (see FIG. 6) are completed. FIG. 13B shows a position deviation response function r(x,y) of the charged particle beam drawing apparatus 10 of the third embodiment at the time when all of the irradiations of the charged particle beam 10a1b (see FIG. 6) in the stripe frame STR1 (see FIG. 6) in the drawing area DA (see FIG. 6) of the workpiece M (see FIG. 6) are completed, where r(x,y)=r1(x,y)+r2(x,y).

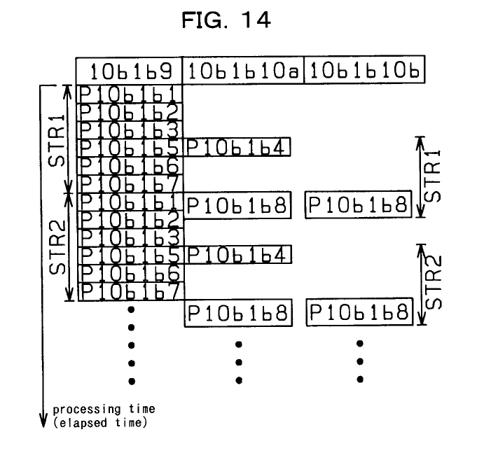

FIG. 14 shows the processing time of the electrical charging effect correction process in the charged particle beam drawing apparatus 10 of the third embodiment. In detail, FIG. 14 shows the processing time (elapsed time) of the electrical charging effect correction process in the charged particle beam drawing apparatus 10 of the third embodiment, wherein the calculations are performed in parallel with the central processing unit (CPU) 10b1b9 (see FIG. 11), and the processing units 10b1b10a, 10b1b10b (see FIG. 11) of the high speed processing unit 10b1b10 (see FIG. 11), wherein the processing speed of each processing unit 10b1b10a, 10b1b10b (see FIG. 11) is higher than the processing speed of the central processing unit (CPU) 10b1b9 (see FIG. 11).

In the charged particle beam drawing apparatus 10 of the third embodiment, as shown in FIG. 13A, the first electrical charging area CA1 is placed in the stripe frame STR1 and in positions which are close to the stripe frame STR1. Namely, the first electrical charging area CA1 is closer to positions, where the charged particle beam 10a1b is applied, and where electric charges exist, than the second electrical charging area CA2, wherein the size of meshes in the second electrical charging area CA2 is larger than the size of meshes in the first electrical charging area CA1. In other words, the second electrical charging area CA2 is more distant from the positions, where the charged particle beam 10a1b is applied, and where electric charges exist, than the first electrical charging area CA1. That is to say, the second electrical charging area CA2 is separated from the stripe frame STR1, and distance between the second electrical charging area CA2 and the stripe frame STR1 is equal to or more than 1 mm.

In the charged particle beam drawing apparatus 10 of the third embodiment, two processing units 10b1b10a, 10b1b10b (see FIG. 11) are provided with the high speed processing unit 10b1b10 (see FIG. 11). The processing unit 10b1b10a is used for performing a first convolution calculation of an electrical charging amount distribution C1(x,y) and a position deviation response function r1(x,y) (see FIG. 13B) corresponding to the first electrical charging area CA1 (see FIG. 13A) in the electrical charging amount distribution map (see FIG. 13A), wherein the size of each mesh of the electrical charging amount distribution C1(x,y) is equal to the size of each small mesh in the first electrical charging area CA1 (see FIG. 13A) in the electrical charging amount distribution map (see FIG. 13A), and wherein the first convolution calculation is as follows.

∫r1(x−x′,y−y′)C1(x′,y′)

The processing unit 10b1b10b is used for performing a second convolution calculation of an electrical charging amount distribution C2(x,y) and a position deviation response function r2(x,y) (see FIG. 13B) corresponding to the second electrical charging area CA2 (see FIG. 13A) in the electrical charging amount distribution map (see FIG. 13A), wherein the size of each mesh of the electrical charging amount distribution C2(x,y) is equal to the size of each large mesh in the second electrical charging area CA2 (see FIG. 13A) in the electrical charging amount distribution map (see FIG. 13A), and wherein the second convolution calculation is as follows.

∫r2(x−x′,y−y′)C2(x′,y′)

In the charged particle beam drawing apparatus 10 of the third embodiment, the position deviation amount map p(x,y) is calculated on the basis of a sum of a result of the first convolution calculation by the processing units 10b1b10a and a result of the second convolution calculation by the processing units 10b1b10b. The sum is as follows.

∫r1(x−x′,y−y′)C1(x′,y′)

+∫r2(x−x′,y−y′)C2(x′,y′)

In other words, in the charged particle beam drawing apparatus 10 of the third embodiment, as shown in FIG. 14, the first convolution calculation P10b1b8 (see FIG. 14) of the electrical charging amount distribution C1(x,y) including the first electrical charging area CA1 (see FIG. 13A) having small mesh size in the electrical charging amount distribution map (see FIG. 13A) and the position deviation response function r1(x,y) (see FIG. 13B) corresponding to the first electrical charging area CA1 (see FIG. 13A) in the electrical charging amount distribution map (see FIG. 13A) is performed by using the processing unit 10b1b10a (see FIGS. 11 and 14), and the second convolution calculation P10b1b8 (see FIG. 14) of the electrical charging amount distribution C2(x,y) including the second electrical charging area CA2 (see FIG. 13A) having large mesh size in the electrical charging amount distribution map (see FIG. 13A) and the position deviation response function r2(x,y) (see FIG. 13B) corresponding to the second electrical charging area CA2 (see FIG. 13A) in the electrical charging amount distribution map (see FIG. 13A) is performed by using the processing unit 10b1b10b (see FIGS. 11 and 14), in parallel.

Namely, in the charged particle beam drawing apparatus 10 of the third embodiment, a convolution calculation of an electrical charging amount distribution C(x,y) and a position deviation response function r(x,y) is performed in parallel by using the processing unit 10b1b10a (see FIGS. 11 and 14) and the processing unit 10b1b10b (see FIGS. 11 and 14). The convolution calculation of the electrical charging amount distribution C(x,y) and the position deviation response function r(x,y) is as follows.

∫r(x−x′,y−y′)C(x′,y′)

Accordingly, in the charged particle beam drawing apparatus 10 of the third embodiment, the processing time for the convolution calculation P10b1b8 (see FIG. 14) of the electrical charging amount distribution C(x,y) and the position deviation response function r(x,y) can be shorter than a case (see FIG. 10A) wherein the convolution calculation P10b1b8 (see FIG. 10A) of the electrical charging amount distribution C(x,y) and the position deviation response function r(x,y) is not performed in parallel by the processing units 10b1b10a, 10b1b10b (see FIGS. 11 and 14).

Also, in the charged particle beam drawing apparatus 10 of the third embodiment, the processing time for the convolution calculation P10b1b8 (see FIG. 14) of the electrical charging amount distribution C(x,y) and the position deviation response function r(x,y) can be shorter than a case (see FIGS. 9B and 10A) wherein the electrical charging amount distribution map (see FIG. 9b) calculated by the electrical charging amount distribution calculating portion 10b1b7 (see FIG. 3) does not include an electrical charging area having large mesh size, and wherein all of the electrical charging amount distribution map is constituted by the electrical charging area having small mesh size.

By the way, although only the calculations P10b1b4, P10b1b8 (see FIG. 14) which have a large processing load are performed by using the processing units 10b1b10a, 10b1b10b (see FIG. 14) in order to decrease the processing time (see FIG. 14) of the electrical charging effect correction process in the charged particle beam drawing apparatus 10 of the third embodiment, not only the calculations P10b1b4, P10b1b8 (see FIG. 14) which have the large processing load, but also the calculations P10b1b1, P10b1b2, P10b1b3, P10b1b5, P10b1b6, P10b1b7 (see FIG. 14) which have a small processing load can be performed by using the processing units 10b1b10a, 10b1b10b (see FIG. 14) in order to decrease the processing time (see FIG. 14) of the electrical charging effect correction process in another case. However, if the non-mount type GPUs (graphics processing units) are used as the two processing units 10b1b10a, 10b1b10b (see FIGS. 11 and 14), namely if the GPUs which are not mounted on the control circuit board of the charged particle beam drawing apparatus 10 are used as the two processing units 10b1b10a, 10b1b10b (see FIGS. 11 and 14), although the processing speed of the processing units 10b1b10a, 10b1b10b (see FIGS. 11 and 14) is higher than the processing speed of the central processing unit (CPU) 10b1b9 (see FIGS. 11 and 14), an access speed from the pattern area density distribution calculating portion 10b1b1 (see FIG. 11) etc. to the processing units 10b1b10a, 10b1b10b (see FIGS. 11 and 14) is lower than an access speed from the pattern area density distribution calculating portion 10b1b1 (see FIG. 11) etc. to the central processing unit (CPU) 10b1b9 (see FIGS. 11 and 14). Accordingly, if the calculations P10b1b1, P10b1b2, P10b1b3, P10b1b5, P10b1b6, P10b1b7 (see FIG. 14) which have the small processing load are performed by using the processing units 10b1b10a, 10b1b10b (see FIG. 14), the processing time of the electrical charging effect correction process is not shorter than the charged particle beam drawing apparatus 10 of the third embodiment. In detail, if the calculations P10b1b1, P10b1b2, P10b1b3, P10b1b5, P10b1b6, P10b1b7 (see FIG. 14) which have the small processing load are performed by using the processing units 10b1b10a, 10b1b10b (see FIG. 14), the processing time of the electrical charging effect correction process can be longer than the charged particle beam drawing apparatus 10 of the third embodiment.

Preferably, in the charged particle beam drawing apparatus 10 of the third embodiment, the number of the meshes included in the first electrical charging area CA1 (see FIG. 13A) of the electrical charging amount distribution map (see FIG. 13A) and the number of the meshes included in the second electrical charging area CA2 (see FIG. 13A) of the electrical charging amount distribution map (see FIG. 13A) are approximately equal. Consequently, in the charged particle beam drawing apparatus 10 of the third embodiment, the processing time for the convolution calculation P10b1b8 (see FIG. 14) of the electrical charging amount distribution C1(x,y) including the first electrical charging area CA1 (see FIG. 13A) having small mesh size in the electrical charging amount distribution map (see FIG. 13A) and the position deviation response function r1(x,y) (see FIG. 13B) corresponding to the first electrical charging area CA1 (see FIG. 13A) in the electrical charging amount distribution map (see FIG. 13A), by using the processing unit 10b1b10a (see FIGS. 11 and 14), and the processing time for the convolution calculation P10b1b8 (see FIG. 14) of the electrical charging amount distribution C2(x,y) including the second electrical charging area CA2 (see FIG. 13A) having large mesh size in the electrical charging amount distribution map (see FIG. 13A) and the position deviation response function r2(x,y) (see FIG. 13B) corresponding to the second electrical charging area CA2 (see FIG. 13A) in the electrical charging amount distribution map (see FIG. 13A), by using the processing unit 10b1b10b (see FIGS. 11 and 14), can be approximately equal.

The electrical charging effect correction processing portion 10b1b of the charged particle beam drawing apparatus 10 of a forth embodiment, includes two processing units 10b1b10a, 10b1b10b in the high speed processing unit 10b1b10, as well as the electrical charging effect correction processing portion 10b1b (see FIG. 11) of the charged particle beam drawing apparatus 10 of the third embodiment.

The position deviation amount p of the charged particle beam 10a1b (see FIG. 1) obtained by performing the convolution calculation of the electrical charging amount distribution C(x,y) and the position deviation response function r(x,y), can be divided into a first component px in x direction and a second component py in y direction which is perpendicular to the x direction. Accordingly, in the charged particle beam drawing apparatus 10 of the forth embodiment, a first position deviation response function rₓ(x,y) for calculating the first component px in the x direction of the position deviation amount p, and a second position deviation response function r_{y}(x,y) for calculating the second component py in the y direction of the position deviation amount p, are respectively provided.

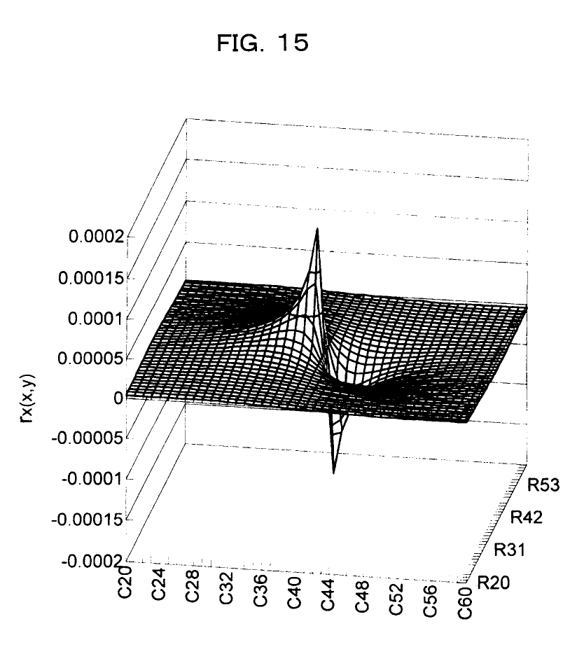

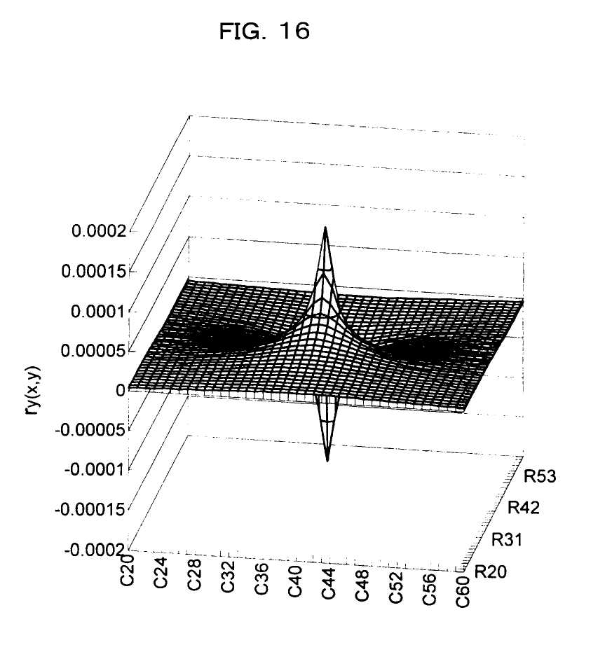

FIG. 15 shows an example of the first position deviation response function rₓ(x,y) for calculating the first component px in the x direction of the position deviation amount p. FIG. 16 shows an example of the second position deviation response function r_{y}(x,y) for calculating the second component py in the y direction of the position deviation amount p.

In the charged particle beam drawing apparatus 10 of the forth embodiment, a following convolution calculation of the first position deviation response function rₓ(x,y) for calculating the first component px in the x direction of the position deviation amount p, and the electrical charging amount distribution C(x,y) is performed by using the processing unit 10b1b10a (see FIG. 11) of the high speed processing unit 10b1b10 (see FIG. 11).

∫rₓ(x−x′,y−y′)C(x′,y′)

In the charged particle beam drawing apparatus 10 of the forth embodiment, a following convolution calculation of the second position deviation response function r_{y} (x,y) for calculating the second component py in the y direction of the position deviation amount p, and the electrical charging amount distribution C(x,y) is performed in parallel by using the processing unit 10b1b10b (see FIG. 11) of the high speed processing unit 10b1b10 (see FIG. 11).

∫r_{y}(x−x′,y−y′)C(x′,y′)

In other words, in the charged particle beam drawing apparatus 10 of the forth embodiment, a following convolution calculation of the electrical charging amount distribution C(x,y) and the position deviation response function r(x,y) is performed in parallel by the processing units 10b1b10a, 10b1b10b (see FIG. 11).

∫r(x−x′,y−y′)C(x′,y′)=(∫rₓ(x−x′)C(x′,y′), ∫r_{y}(x−x′,y−y′)C(x′,y′))

Consequently, the processing time of the electrical charging effect correction process of the charged particle beam drawing apparatus 10 of the forth embodiment is approximately equal to the processing time (see FIG. 14) of the electrical charging effect correction process of the charged particle beam drawing apparatus 10 of the third embodiment.

Accordingly, in the charged particle beam drawing apparatus 10 of the forth embodiment, the processing time for the convolution calculation P10b1b8 (see FIG. 14) of the electrical charging amount distribution C(x,y) and the position deviation response function r(x,y) can be shorter than a case (see FIGS. 3 and 10A) wherein the convolution calculation P10b1b8 (see FIG. 10A) of the electrical charging amount distribution C(x,y) and the position deviation response function r(x,y) is not performed in parallel by the processing units 10b1b10a, 10b1b10b (see FIGS. 11 and 14).

In the electrical charging effect correction processing portion 10b1b of the charged particle beam drawing apparatus 10 of a fifth embodiment, two processing units 10b1b10a, 10b1b10b are provided with the high speed processing unit 10b1b10, as well as the electrical charging effect correction processing portion 10b1b (see FIG. 11) of the charged particle beam drawing apparatus 10 of the third embodiment.

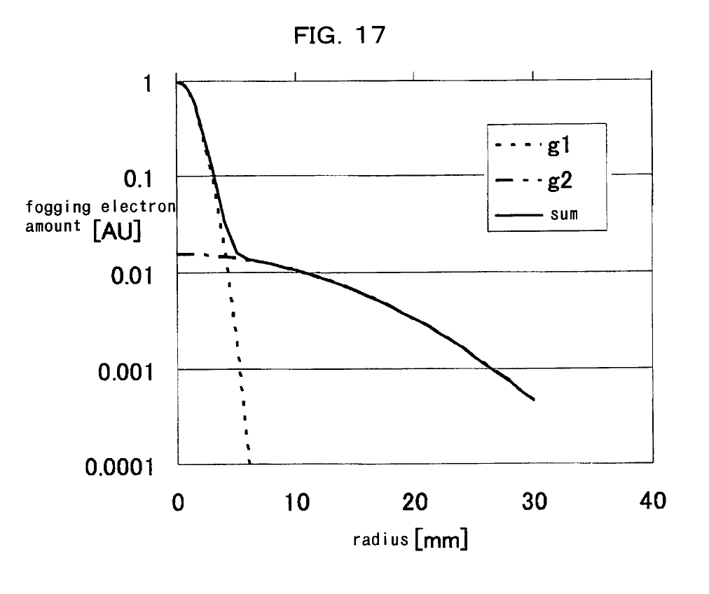

FIG. 17 is a graph showing a relation between a distance (radius) from an irradiation position of the charged particle beam 10a1b and a fogging charged particle amount (fogging electron amount). In FIG. 17, a horizontal axis of the graph shows the distance (radius) from the irradiation position of the charged particle beam 10a1b, and a vertical axis of the graph shows the fogging charged particle amount (fogging electron amount). Namely, FIG. 17 shows that the charged particle beam 10a1b is applied to a position where a value of the horizontal axis is zero.

The inventors discovered in their research that a fogging charged particle distribution (fogging electron distribution) shown in FIG. 17 has a first part which is close to the irradiation position of the charged particle beam 10a1b, and a second part which is apart from the irradiation position of the charged particle beam 10a1b, wherein a distance from the irradiation position of the charged particle beam 10a1b to the first part is less than 2 or 3 millimeters, and a distance from the irradiation position of the charged particle beam 10a1b to the second part is equal to or more than 2 or 3 millimeters, and wherein the first part is described as a first Gaussian distribution (normal distribution) g1(x,y), the second part is described as a second Gaussian distribution (normal distribution) g2(x,y), and the first Gaussian distribution g1(x,y) is different from the second Gaussian distribution g2(x,y). In other words, the inventors discovered in their research that if the fogging charged particle distribution (fogging electron distribution) is described as only one Gaussian distribution g(x,y), the electrical charging effect correction process cannot be precisely performed.

Accordingly, in the charged particle beam drawing apparatus 10 of the fifth embodiment, the first Gaussian distribution g1(x,y) and the second Gaussian distribution g2(x,y) are provided, respectively. Following equations show the first Gaussian distribution g1(x,y) and the second Gaussian distribution g2(x,y) wherein a fogging scattering radius σ₂ of the second Gaussian distribution g2(x,y) is larger than a fogging scattering radius σ_{f} of the first Gaussian distribution g1(x,y).

g1(x,y)=(1/πσ₁²)×exp(−(x²+y²)/σ₁²)

g2(x,y)=(1/πσ₂²)×exp(−(x²+y²)/σ₂²)

In detail, the fogging charged particle distribution g(x,y) is calculated by the fogging charged particle amount distribution calculating portion 10b1b4 (see FIG. 11), as a sum of the first Gaussian distribution g1(x,y) and the second Gaussian distribution g2(x,y). A following equation shows the fogging charged particle distribution g(x,y).

g(x,y)=(1/πσ₁²)×exp(−(x²+y²)/σ₁²)+(1/πσhd 2²)×exp(−(x²−y²)σ₂²)

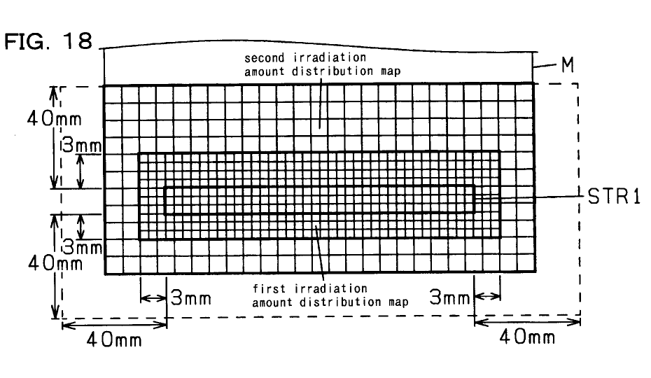

In the charged particle beam drawing apparatus 10 of the fifth embodiment, a first irradiation amount distribution map (see FIG. 18), and a second irradiation amount distribution map (see FIG. 18) which has larger mesh size than the first irradiation amount distribution map, are calculated by the irradiation amount distribution calculating portion 10b1b3 (see FIG. 11). FIG. 18 shows the first irradiation amount distribution map and the second irradiation amount distribution map of the charged particle beam drawing apparatus 10 of the fifth embodiment at the time when all of irradiations of the charged particle beam 10a1b in the stripe frame STR1 (see FIG. 6) in the drawing area DA (see FIG. 6) of the workpiece M is completed.

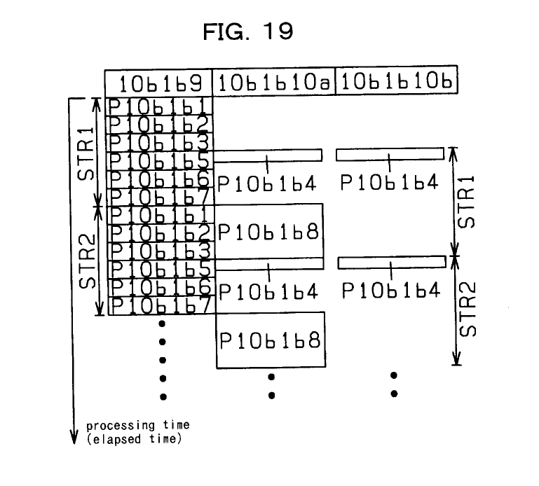

FIG. 19 shows the processing time of the electrical charging effect correction process in the charged particle beam drawing apparatus 10 of the fifth embodiment. In detail, FIG. 19 shows the processing time (elapsed time) of the electrical charging effect correction process in the charged particle beam drawing apparatus 10 of the fifth embodiment, wherein the calculations are performed in parallel with the central processing unit (CPU) 10b1b9 (see FIG. 11), and the processing units 10b1b10a, 10b1b10b (see FIG. 11) of the high speed processing unit 10b1b10 (see FIG. 11), wherein the processing speed of each processing unit 10b1b10a, 10b1b10b (see FIG. 11) is higher than the processing speed of the central processing unit (CPU) 10b1b9 (see FIG. 11).

In the charged particle beam drawing apparatus 10 of the fifth embodiment, the high speed processing unit 10b1b10 (see FIG. 11) has the processing unit 10b1b10a (see FIG. 11) for performing a first convolution calculation P10b1b4 (see FIG. 19) of a first irradiation amount distribution E1(x,y) and the first Gaussian distribution g1(x,y), wherein the first irradiation amount distribution E1(x,y) corresponds to the first irradiation amount distribution map (see FIG. 18) which has smaller mesh size than the second irradiation amount distribution map (see FIG. 18), and wherein the first convolution calculation is as follows.

∫g1(x−x′,y−y′)E1(x′,y′)

In the charged particle beam drawing apparatus 10 of the fifth embodiment, the high speed processing unit 10b1b10 (see FIG. 11) has the processing unit 10b1b10b (see FIG. 11) for performing a second convolution calculation P10b1b4 (see FIG. 19) of a second irradiation amount distribution E2(x,y) and the second Gaussian distribution g2(x,y), wherein the second irradiation amount distribution E2(x,y) corresponds to the second irradiation amount distribution map (see FIG. 18) which has larger mesh size than the first irradiation amount distribution map (see FIG. 18), and wherein the second convolution calculation is as follows.

∫g2(x−x′,y−y′)E2(x′,y′)

Namely, in the charged particle beam drawing apparatus 10 of the fifth embodiment, the first convolution calculation P10b1b4 (see FIG. 19) of the first irradiation amount distribution E1(x,y) and the first Gaussian distribution g1(x,y) is performed by using the processing unit 10b1b10a (see FIGS. 11 and 19), wherein the first irradiation amount distribution E1(x,y) corresponds to the first irradiation amount distribution map (see FIG. 18) which has smaller mesh size than the second irradiation amount distribution map (see FIG. 18). Also, the second convolution calculation P10b1b4 (see FIG. 19) of the second irradiation amount distribution E2(x,y) and the second Gaussian distribution g2(x,y) is performed in parallel by using the processing unit 10b1b10b (see FIGS. 11 and 19), wherein the second irradiation amount distribution E2(x,y) corresponds to the second irradiation amount distribution map (see FIG. 18) which has larger mesh size than the first irradiation amount distribution map (see FIG. 18).

In other words, in the charged particle beam drawing apparatus 10 of the fifth embodiment, a convolution calculation which is a sum of the first convolution calculation and the second convolution calculation, of an irradiation amount distribution E(x,y) and a fogging charged particle distribution (fogging electron distribution) g(x,y) is performed in parallel by using the processing units 10b1b10a, 10b1b10b (see FIGS. 11 and 19), wherein the irradiation amount distribution E(x,y) and the fogging charged particle distribution (fogging electron distribution) g(x,y) are as follows.

E(x,y)=E1(x,y)+E2(x,y)

g(x,y)=g1(x,y)+g2(x,y)

Consequently, in the charged particle beam drawing apparatus 10 of the fifth embodiment, the processing time for the convolution calculation P10b1b4 (see FIG. 19) of the irradiation amount distribution E(x,y) and the fogging charged particle distribution (fogging electron distribution) g(x,y) can be shorter than a case (see FIG. 10A) in which the convolution calculation P10b1b4 (see FIG. 10A) of the irradiation amount distribution E(x,y) and the fogging charged particle distribution (fogging electron distribution) g(x,y) is not performed in parallel.

Preferably, in the charged particle beam drawing apparatus 10 of the fifth embodiment, the number of the meshes included in the first irradiation amount distribution map (see FIG. 18) and the number of the meshes included in the second irradiation amount distribution map (see FIG. 18) are approximately equal. Consequently, in the charged particle beam drawing apparatus 10 of the fifth embodiment, the processing time for the first convolution calculation P10b1b4 (see FIG. 19) of the first irradiation amount distribution E1(x,y) and the first Gaussian distribution g1(x,y), by using the processing unit 10b1b10a (see FIGS. 11 and 19), and the processing time for the second convolution calculation P10b1b4 (see FIG. 19) of the second irradiation amount distribution E2(x,y) and the second Gaussian distribution g2(x,y), by using the processing unit 10b1b10b (see FIGS. 11 and 19), can be approximately equal, wherein the first irradiation amount distribution E1(x,y) corresponds to the first irradiation amount distribution map (see FIG. 18) which has smaller mesh size than the second irradiation amount distribution map (see FIG. 18), and wherein the second irradiation amount distribution E2(x,y) corresponds to the second irradiation amount distribution map (see FIG. 18) which has larger mesh size than the first irradiation amount distribution map (see FIG. 18).

In the charged particle beam drawing apparatus 10 of the sixth embodiment, above mentioned first to fifth embodiments and their variations are appropriately combined.

As many apparently widely different embodiments of this invention may be made without departing from the spirit and scope thereof, it is to be understood that the invention is not limited to the specific embodiments thereof except as defined in the appended claims.

What is claimed is:

1. A charged particle beam drawing apparatus, comprising:
a drawing portion for drawing patterns corresponding to figures included in a drawing data, on a resist of a workpiece by applying a charged particle beam to the resist, the resist being applied to an upper surface of the workpiece;
a pattern area density distribution calculating portion for calculating a pattern area density distribution of patterns drawn by the charged particle beam;
a dose distribution calculating portion for calculating a dose distribution on the basis of the pattern area density distribution and a backscattering ratio of charged particles in the resist;
an irradiation amount distribution calculating portion for calculating an irradiation amount distribution, the irradiation amount distribution being a product of the pattern area density distribution by the dose distribution;
a fogging charged particle amount distribution calculating portion for performing a convolution calculation of the irradiation amount distribution and a fogging charged particle distribution;
an irradiation time calculating portion for calculating an irradiation time of the charged particle beam for drawing the patterns;
an elapsed time calculating portion for calculating an elapsed time;
an electrical charging amount distribution calculating portion for calculating an electrical charging amount distribution of the resist of the workpiece, the resist of the workpiece being electrically charged by an irradiation of the charged particle beam;
a position deviation amount map calculating portion for performing a convolution calculation of the electrical charging amount distribution and a position deviation response function;
a central processing unit used for a calculation in the pattern area density distribution calculating portion, a calculation in the dose distribution calculating portion, a calculation in the irradiation amount distribution calculating portion, a calculation in the irradiation time calculating portion, a calculation in the elapsed time calculating portion and a calculation in the electrical charging amount distribution calculating portion; and
a high speed processing unit used for the calculation in the fogging charged particle amount distribution calculating portion and the calculation in the position deviation amount map calculating portion, wherein a processing speed of the high speed processing unit is higher than a processing speed of the central processing unit.

2. The charged particle beam drawing apparatus according to claim 1, wherein the electrical charging amount distribution calculating portion calculates an electrical charging amount distribution map including a first electrical charging area and a second electrical charging area, size of each mesh in the second electrical charging area being larger than size of each mesh in the first electrical charging area,
wherein the high speed processing unit has a first processing unit and a second processing unit,
wherein the first processing unit is used for performing a first convolution calculation of an first electrical charging amount distribution and a first position deviation response function,
wherein size of each mesh of the first electrical charging amount distribution is equal to the size of each mesh in the first electrical charging area,
wherein the first position deviation response function corresponds to the first electrical charging area,
wherein the second processing unit is used for performing a second convolution calculation of an second electrical charging amount distribution and a second position deviation response function,
wherein size of each mesh of the second electrical charging amount distribution is equal to the size of each mesh in the second electrical charging area, and
wherein the second position deviation response function corresponds to the second electrical charging area.

3. The charged particle beam drawing apparatus according to claim 2, wherein the number of meshes in the first electrical charging area and the number of meshes in the second electrical charging area are approximately equal.

4. The charged particle beam drawing apparatus according to claim 1, wherein the high speed processing unit has a first processing unit and a second processing unit,
wherein the first processing unit is used for performing a first convolution calculation of the electrical charging amount distribution and a first position deviation response function for calculating a first component in x direction of a position deviation amount, and
wherein the second processing unit is used for performing a second convolution calculation of the electrical charging amount distribution and a second position deviation response function for calculating a second component in y direction of the position deviation amount.

5. The charged particle beam drawing apparatus according to claim 1, wherein the irradiation amount distribution calculating portion calculates a first irradiation amount distribution map and a second irradiation amount distribution map, size of each mesh in the second irradiation amount distribution map being larger than size of each mesh in the first irradiation amount distribution map,
wherein the fogging charged particle amount distribution calculating portion calculates the fogging charged particle distribution as a sum of a first Gaussian distribution and a second Gaussian distribution, a fogging scattering radius of the second Gaussian distribution being larger than a fogging scattering radius of the first Gaussian distribution,
wherein the high speed processing unit has a first processing unit and a second processing unit,
wherein the first processing unit is used for performing a first convolution calculation of an first irradiation amount distribution and the first Gaussian distribution,
wherein size of each mesh of the first irradiation amount distribution is equal to the size of each mesh in the first irradiation amount distribution map,
wherein the second processing unit is used for performing a second convolution calculation of an second irradiation amount distribution and the second Gaussian distribution, and
wherein size of each mesh of the second irradiation amount distribution is equal to the size of each mesh in the second irradiation amount distribution map.

6. An electrical charging effect correction method of a charged particle beam drawing apparatus for drawing patterns corresponding to figures included in a drawing data, on a resist of a workpiece by applying a charged particle beam to the resist, the resist being applied to an upper surface of the workpiece, comprising:
performing a calculation of a pattern area density distribution of patterns drawn by the charged particle beam, by using a central processing unit;
performing a calculation of a dose distribution on the basis of the pattern area density distribution and a backscattering ratio of charged particles in the resist, by using the central processing unit;
performing a calculation of an irradiation amount distribution by using the central processing unit, the irradiation amount distribution being a product of the pattern area density distribution by the dose distribution;
performing a convolution calculation of the irradiation amount distribution and a fogging charged particle distribution, by using a high speed processing unit, wherein a processing speed of the high speed processing unit is higher than a processing speed of the central processing unit;
performing a calculation of an irradiation time of the charged particle beam for drawing the patterns, by using the central processing unit;
performing a calculation of an elapsed time by using the central processing unit;
performing a calculation of an electrical charging amount distribution of the resist of the workpiece by using the central processing unit, the resist of the workpiece being electrically charged by an irradiation of the charged particle beam; and
performing a convolution calculation of the electrical charging amount distribution and a position deviation response function, by using the high speed processing unit.

7. The electrical charging effect correction method of the charged particle beam drawing apparatus according to claim 6, wherein when the calculation of the electrical charging amount distribution is performed, an electrical charging amount distribution map including a first electrical charging area and a second electrical charging area is calculated, size of each mesh in the second electrical charging area being larger than size of each mesh in the first electrical charging area,
wherein the high speed processing unit has a first processing unit and a second processing unit,
wherein the first processing unit is used for performing a first convolution calculation of an first electrical charging amount distribution and a first position deviation response function,
wherein size of each mesh of the first electrical charging amount distribution is equal to the size of each mesh in the first electrical charging area,
wherein the first position deviation response function corresponds to the first electrical charging area,
wherein the second processing unit is used for performing a second convolution calculation of an second electrical charging amount distribution and a second position deviation response function,
wherein size of each mesh of the second electrical charging amount distribution is equal to the size of each mesh in the second electrical charging area, and
wherein the second position deviation response function corresponds to the second electrical charging area.

8. The electrical charging effect correction method of the charged particle beam drawing apparatus according to claim 7, wherein the number of meshes in the first electrical charging area and the number of meshes in the second electrical charging area are approximately equal.

9. The electrical charging effect correction method of the charged particle beam drawing apparatus according to claim 6, wherein the high speed processing unit has a first processing unit and a second processing unit,
wherein the first processing unit is used for performing a first convolution calculation of the electrical charging amount distribution and a first position deviation response function for calculating a first component in x direction of a position deviation amount, and
wherein the second processing unit is used for performing a second convolution calculation of the electrical charging amount distribution and a second position deviation response function for calculating a second component in y direction of the position deviation amount.

10. The electrical charging effect correction method of the charged particle beam drawing apparatus according to claim 6, wherein when the calculation of the irradiation amount distribution is performed, a first irradiation amount distribution map and a second irradiation amount distribution map are calculated, size of each mesh in the second irradiation amount distribution map being larger than size of each mesh in the first irradiation amount distribution map,
wherein when the convolution calculation of the electrical charging amount distribution and the position deviation response function is performed, the fogging charged particle distribution is calculated as a sum of a first Gaussian distribution and a second Gaussian distribution, a fogging scattering radius of the second Gaussian distribution being larger than a fogging scattering radius of the first Gaussian distribution,
wherein the high speed processing unit has a first processing unit and a second processing unit,
wherein the first processing unit is used for performing a first convolution calculation of an first irradiation amount distribution and the first Gaussian distribution,
wherein size of each mesh of the first irradiation amount distribution is equal to the size of each mesh in the first irradiation amount distribution map,
wherein the second processing unit is used for performing a second convolution calculation of an second irradiation amount distribution and the second Gaussian distribution, and
wherein size of each mesh of the second irradiation amount distribution is equal to the size of each mesh in the second irradiation amount distribution map.
